(19) United States
(12) Patent Application Publication
(10) Pub. No.: US 2026/0344587 A1
(43) Pub. Date: Nov. 5, 2026

(54) MULCHING VACUUMS AND METHODS OF USE

(71) Applicant: Milwaukee Electric Tool Corporation, Brookfield, WI (US)

(72) Inventors: Benjamin J. Owen-Block, Brookfield, WI (US); Joseph H. Maloney, Brookfield, WI (US); Drake J. Schlosser, Hartford, WI (US); Daniel I. Arechiga, Brookfield, WI (US); Matthew T. Bakall, Brookfield, WI (US); Andrew J. Wachtel, Brookfield, WI (US); Connor P. Sprague, Milwaukee, WI (US); Steve J. Ennesser, Mequon, WI (US); Jaydeep S. Khopkar, Brookfield, WI (US); Sourav S. Sen, Brookfield, WI (US)

(21) Appl. No.: 19/656,353

(22) Filed: Apr. 23, 2026

Related U.S. Application Data
(60) Provisional application No. 63/798,125, filed on May 1, 2025.

(51) Int. Cl. A01G 20/47; A45F 3/04; A47L 7/00; A47L 9/14; A47L 9/28; A47L 9/32

(52) U.S. Cl. CPC A01G 20/47; A45F 3/04; A47L 7/009; A47L 9/1418; A47L 9/149; A47L 9/2884; A47L 9/322

(57) ABSTRACT

A mulching vacuum tool includes an inlet nozzle, a housing, a fan assembly, an outlet nozzle, and a debris collection bag. The housing defines an inlet coupled to the inlet nozzle and an outlet to direct debris from the housing. The fan assembly is mounted within the housing between the inlet and the outlet. The outlet nozzle is coupled to the outlet.

### CROSS-REFERENCE TO RELATED APPLICATIONS

The present application claims priority to U.S. application Ser. No. 63/798,125 filed on Jan. 6, 2026, the disclosure of which is incorporated by reference herein in its entirety.

### FIELD

The present disclosure relates generally to power tools, such as mulching vacuums.

### BACKGROUND

Mulching vacuums are generally utilized in outdoor environments to, for example, dispose of environmental debris such as leaves, grass clippings, etc. A typical mulching vacuum utilizes a fan to generate an airflow which sucks the debris into and through the mulching vacuum. The debris may be chopped, e.g. mulched, by an impeller blade within the mulching vacuum, and then deposited in a debris bag of the mulching vacuum.

Some mulching vacuum systems may present challenges related to ergonomics, debris collection, and performance. For example, the weight distribution and handle placement of certain tools can create a large moment of inertia, making the tool difficult to maneuver and potentially contributing to user fatigue. The debris collection containers associated with these systems can also exhibit certain drawbacks. Bag closures, such as zippers, may become clogged with debris, and the construction of the debris collection container can sometimes restrict airflow, which may reduce suction performance. Furthermore, some systems can experience performance variability when ingesting wet or large debris, which can lead to clogging and operational interruptions that require manual clearing. The control systems for the fan motor in certain configurations may not adapt to all load variations, which can in some instances result in motor over-speed or stall conditions.

Therefore, it may be desirable to provide mulching vacuum systems that address challenges associated with user ergonomics, debris collection, operational performance, and reliability.

### BRIEF DESCRIPTION

Aspects and advantages of the present disclosure will be set forth in part in the following description, or may be obvious from the description, or may be learned through practice of the technology.

In accordance with one embodiment, a debris collection bag includes a fabric body, a bag clasp, and a secondary clasp. The fabric body may define an inlet opening, a bag cavity to hold debris therein, and an outlet opening. The fabric body may include a foldable closing portion extending from the outlet opening and a storage portion extending from the foldable closing portion, the foldable closing portion being movable between a folded-closed position and an unfolded-open position. The bag clasp may be attached to the fabric body at the foldable closing portion to selectively hold the foldable closing portion in the folded-closed position. The secondary clasp may be attached to the fabric body in selective connection with the bag clasp at the foldable closing portion.

In accordance with another embodiment, a mulching vacuum tool includes an inlet nozzle, a housing, a fan assembly, an outlet nozzle, and a user harness. The housing may define an inlet coupled to the inlet nozzle and an outlet to direct debris from the housing. The fan assembly may be mounted within the housing between the inlet and the outlet. The outlet nozzle may be coupled to the outlet. The user harness may include a left shoulder strap, a right shoulder strap, a back panel joining the left shoulder strap and the right shoulder strap at a rear portion of the user harness, a front connection panel selectively joining the left shoulder strap and the right shoulder strap at a front portion of the user harness, and a central anchor strap extending between the left shoulder strap and the right shoulder strap in selective connection with the housing.

In accordance with yet another embodiment, a mulching vacuum tool includes an inlet nozzle, a housing, a fan assembly, an outlet nozzle, and a pair of batteries. The housing may define an inlet coupled to the inlet nozzle and an outlet to direct debris from the housing. The housing may include a main body, a first handle extending radially outward from the main body, and a second handle extending radially outward from the main body apart from the first handle. The fan assembly may be mounted within the housing between the inlet and the outlet. The outlet nozzle may be coupled to the outlet. The pair of batteries may be separately supported on the housing. The pair of batteries may include a first battery pack and a second battery pack. The pair of batteries, the fan assembly, and the housing may define a center of gravity between the first and second handles.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 provides a perspective view of an operator, user harness, mulching vacuum unit, and debris bag in accordance with embodiments of the present disclosure;

FIG. 2 provides a perspective of a mulching vacuum unit and debris bag in accordance with embodiments of the present disclosure;

FIG. 3 provides a side perspective view of the exemplary mulching vacuum unit and debris bag of FIG. 2;

FIG. 4 provides a top perspective view of the exemplary mulching vacuum unit and debris bag of FIG. 2;

FIG. 5 provides a side elevation view of a debris bag for an outdoor tool in accordance with embodiments of the present disclosure;

FIG. 6 provides a side elevation view of a debris bag for an outdoor tool in accordance with embodiments of the present disclosure;

FIGS. 7A through 7D provide perspective views of various embodiments of debris bags for an outdoor tool in accordance with embodiments of the present disclosure;

FIG. 8 provides an elevation view of a user harness for an outdoor tool in accordance with embodiments of the present disclosure;

FIG. 9 provides a side perspective view of a portion of the exemplary user harness of FIG. 8;

FIG. 10 provides a rear perspective view of a portion of the exemplary user harness of FIG. 8;

FIG. 11 provides a perspective view of a mulching vacuum unit in accordance with embodiments of the present disclosure;

FIG. 12 provides a perspective view of a mulching vacuum unit in accordance with embodiments of the present disclosure;

FIG. 13 provides a perspective view of a portion of a mulching vacuum unit, including a handle assembly in accordance with embodiments of the present disclosure;

FIG. 14 provides a perspective view of a portion of the exemplary handle assembly of FIG. 13;

FIG. 15 provides a perspective view of a portion of a portion of an outlet nozzle for a mulching vacuum in accordance with embodiments of the present disclosure;

FIG. 16 provides a perspective view of a portion of a mulching vacuum unit in accordance with embodiments of the present disclosure;

FIG. 17 provides a perspective view of another portion of a mulching vacuum unit in accordance with embodiments of the present disclosure;

FIG. 18 provides a perspective view of a portion of a mulching vacuum unit and debris bag, including a magnified view of a closure assembly, in accordance with embodiments of the present disclosure;

FIG. 19 provides a perspective view of a mixed-flow impeller of a fan assembly for an outdoor tool in accordance with embodiments of the present disclosure;

FIG. 20 provides a simplified plan view of a mixed-flow impeller of a fan assembly within an impeller chamber of an outdoor tool in accordance with embodiments of the present disclosure;

FIG. 21 provides a sectional view of a mulching vacuum unit in accordance with embodiments of the present disclosure;

FIG. 22 provides a side perspective view of a portion of an inlet nozzle of an outdoor tool in accordance with embodiments of the present disclosure;

FIG. 23 provides a side perspective view of a portion of an inlet nozzle of an outdoor tool in accordance with embodiments of the present disclosure;

FIG. 24 provides a sectional view of a portion of an inlet nozzle of an outdoor tool in accordance with embodiments of the present disclosure;

FIG. 25 provides a flow chart illustrating a method of operating a mulching vacuum in accordance with embodiments of the present disclosure;

FIG. 26 provides a flow chart illustrating a method of operating a mulching vacuum in accordance with embodiments of the present disclosure; and

FIG. 27 provides a flow chart illustrating a method of operating a mulching vacuum in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first,” “second,” and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Disclosed herein are mulching vacuum tools and related components, such as debris collection containers and user harnesses, that can address certain challenges associated with outdoor power equipment. The disclosed systems and methods can provide certain ergonomic, performance, durability, safety, and operational control characteristics. The configurations can encompass the physical structure of a tool and its accessories, the aerodynamic design of a fan system, and the electronic control logic or controller governing the tool's operation.

In some aspects, a debris collection container for an outdoor tool, such as a mulching vacuum, includes features to enhance durability, ease of use, and airflow. The container may be constructed from a fabric body that defines an overall structure, including an inlet opening for receiving mulched debris from the tool, a bag cavity for accumulating and holding the collected debris, and an outlet opening for emptying the container. The fabric body may extend along a length direction, for example, from a front end where the inlet opening is disposed, to a rear end where the outlet opening is located. To facilitate emptying of debris, the fabric body can include a foldable closing portion that extends from the outlet opening. This portion can be configured to be rolled or folded upon itself to seal the outlet opening. A storage portion may extend from this foldable closing portion, providing additional material to facilitate a secure closure. The foldable closing portion may be movable between a folded-closed position, where the outlet opening is sealed, and an unfolded-open position, where debris can be emptied from the container cavity. Notably, aspects of the present disclosure can reduce or eliminate the need for zippers, which can be prone to clogging with fine dust and debris and can be a point of failure.

A bag clasp can be attached to the fabric body at or near the foldable closing portion (e.g., to secure the foldable closing portion in its closed state). The bag clasp can be, for example, a buckle, a snap, or another suitable fastening mechanism that holds the rolled or folded material in place. In some configurations, a secondary clasp may also be attached to the fabric body (e.g., to engage with or hold the bag clasp). This secondary clasp may be positioned between the outlet opening and the main bag clasp when the container is being closed, helping to initiate or secure an initial fold. The use of clasps and a roll-top closure can facilitate one-handed operation for emptying the container, which may improve user convenience.

The debris collection container may incorporate one or more batten panels. In one embodiment, an upper batten panel is joined to the fabric body, for instance, by being sewn into a pocket or sleeve along a top portion of the container, such as along the storage portion above the main bag cavity. This upper batten panel can provide rigidity along the top of the container, helping it maintain its shape. A harness anchor may be joined to this upper batten panel, providing a connection point for a hook or clasp from a user harness. Additionally, a sidewall batten panel may be joined to the fabric body, positioned laterally outward from the container cavity and below the upper batten panel. These batten panels may be semi-rigid strips, for example, made of a durable polymer or plastic. The strips can be configured to provide sufficient rigidity to inhibit the container from collapsing even when a significant force (e.g., 20 Newtons) is applied. Despite this rigidity, the batten panels can be flexible enough to move with the user and to withstand certain durability tests without breaking or deforming permanently. Notably, the batten panels may structure or enhance safety (e.g., while generally permitting flexibility or folding of the container).

Additionally or alternatively, the fabric body may define one or more expansion pleats. The expansion pleats may be folds in the fabric that can expand to increase the effective surface area of the container without significantly increasing its overall volume. A pleat may extend from a tucked end, which may be located proximal to the inlet opening, to an untucked end distal from the inlet opening. By increasing the breathable surface area of the fabric, these pleats can lower the air resistance of the container, allowing for greater airflow out of the container. This may improve the tool's suction performance while minimizing the amount of dust that is forcefully expelled (e.g., for embodiments in which the debris collection container serves as a primary air outlet).

In other aspects, a mulching vacuum tool system can include a user harness configured for ergonomic comfort and balanced weight distribution. The user harness may be configured in a backpack style, comprising a left shoulder strap and a right shoulder strap. A back panel, which may be made of a breathable or padded material, can join the left and right shoulder straps at a rear portion of the harness. In some designs, the back panel includes an elastic back support element, allowing the harness to conform to the user's body and distribute weight across the shoulders and back. At a front portion of the harness, a front connection panel may selectively join the left and right shoulder straps, which can secure the harness on the user. The tool itself can be supported by a central anchor strap that extends between the left and right shoulder straps and connects to the tool's housing. For example, the front connection panel may include a right clasp on the right shoulder strap and a left clasp on the left shoulder strap, where the clasps are configured to selectively connect to each other. The central anchor strap may be joined to one or both of these clasps, which can position the tool centrally in front of the user.

This harness system can also be configured to support a separate debris container, such as the debris collection container described above or below. The harness may further include a side anchor strap, a rear anchor, and a container anchor. The rear anchor can be disposed at the rear portion of the harness, for example, on the back panel between the shoulder straps. The side anchor strap may extend from this rear anchor, run along the user's side, and connect to the front connection panel. The container anchor, which connects to the debris container to support its weight, may be supported on this side anchor strap. In some embodiments, the container anchor is slidably disposed on the side anchor strap, notably allowing the user to adjust the position of the container for comfort or balance as it fills with debris. Some or all strap adjustments may be located at the front of the harness, notably allowing the user to make changes without removing the tool or harness. The attachment points for the tool and bag can be grouped on one side, for example the right side, such that when the harness is unbuckled, the entire assembly can be put on or taken off (e.g., in a manner similar to a jacket). Optionally, a central anchor mount may be provided on the housing of the tool (e.g., between a first and second handle) to serve as a connection point for the central anchor strap of the user harness.

The mulching vacuum tool may provide an advantageous balance, ergonomics, or safety. The tool may include a housing, which contains a fan assembly and defines an inlet and an outlet. An inlet nozzle can attach to the housing inlet to direct debris into the tool, and an outlet nozzle can attach to the housing outlet to direct the mulched debris into a collection container. The tool can be powered by one or more batteries, such as a plurality or pair of batteries including a first battery pack and a second battery pack. The battery packs may be separately supported on the housing. The placement of the batteries, along with the fan assembly and other components, can be arranged to affect the tool's center of gravity. In some embodiments, the center of gravity is located between a first handle and a second handle of the tool, and the two battery packs are spaced equidistant about this center of gravity. In some cases, the center of gravity may be located within a volume defined by the two battery packs and the space between them.

In certain embodiments, a first handle and a second handle can extend radially outward from a main body of the housing. These handles can be positioned to balance the weight of a motor and batteries, which can contribute to a relatively low moment of inertia. Notably, the tool may feel relatively lighter and more maneuverable during use (e.g., in comparison to existing designs). In some embodiments, the handles wrap around or radially border the battery packs. The handles may notably provide a protective cage for the batteries against drop damage or impacts. The handles may be positioned forward of the batteries, closer to the inlet nozzle. Advantageously, the handle may provide a suitable balance or allow the user to maintain a comfortable in-use nozzle angle and a line of sight to a work piece or nozzle tip.

One or both handles may incorporate a contact bar or wire. The bar or wire can be supported on a grip body of the handle and can be exposed to make contact with an operator's hand, notably drawing away or mitigating the effects of static electricity. In some embodiments, a conductive wire protrudes through both the top and bottom of each handle, creating multiple points of contact to facilitate grounding with the user's hands. These contact points can be placed at locations where an operator may naturally apply pressure, such as a portion of the handle furthest from the user when pushing the tool, and a portion nearest the user when pulling the tool.

The tool may include a fan assembly with a mixed-flow impeller (e.g., including both axial and centrifugal fan characteristics). The impeller may define an axial height and a radial diameter, with an impeller ratio of the axial height to the radial diameter being between approximately 0.5 and 1.5, and in some cases between 0.5 and 1.0. This geometry can allow the fan assembly to be radially compact (e.g., in comparison to existing tools). The impeller can be enclosed within an impeller chamber in the housing, and the radial clearance between the impeller and the housing wall can be varied. A first, smaller radial clearance value can be defined at a chamber intake, while a second, larger radial clearance value can be defined at a chamber exhaust. For example, the first clearance may be between 4 and 7 millimeters, and the second clearance may be between 6 and 9 millimeters. This radial clearance dimension may increase gradually, either linearly or exponentially, along the axial direction from intake to exhaust. This variable clearance design can improve mulching performance and can help reduce clogging, as debris that becomes stuck may do so at the tighter inlet side, which can be more accessible for clearing.

The impeller may define an outlet flow that is directed at an angle between 20 degrees and 80 degrees relative to the fan's axial direction of rotation. This angled flow can provide a pressure and flow range that captures certain benefits of axial fans and centrifugal fans. Notably, consistent tool performance may be maintained under varying loads. To maintain a compact tool size, the impeller may be designed to operate in a high RPM range, such as between 5000 and 16000 RPM. The impeller may define an intake diameter to an exhaust ratio of between 0.5 and 0.9 (e.g., between 0.57 and 0.82), an overall exhaust diameter between 80 and 160 millimeters, and an axial height between 60 and 140 millimeters.

Optionally, the housing itself may feature a voluteless design wherein the air inlet and outlet of the fan section are substantially axial and parallel to each other (e.g., within +/−5 degrees of parallel). This may eliminate the need for a large, spiral-shaped volute casing, resulting in a smaller overall package and lower system resistance for increased airflow.

The inlet nozzle, or tube, may feature a connection mechanism that is secure and easy to operate, such as an insert-and-twist lock. This connection mechanism may use an axial cam surface to create a seal that can prevent debris from escaping, and a radial locking geometry that can provide tactile or audible feedback to the user, which can confirm that the tube is correctly installed and retained against loosening during use. In some designs, a portion of the fan impeller is partially exposed when the inlet nozzle is not attached. To account for this, the inlet nozzle itself may be constructed with a thicker wall or reinforcement in the region that covers the exposed portion of the fan when attached. Alternatively, this section of the tube may include a shroud element, such as a durable insert made of metal or a composite material, to provide additional strength and safety. A lockout mechanism may also be included, such as a sensor that detects the presence of the tube and can prevent tool operation if the tube is not properly attached.

The tool can further incorporate control methods for handling operational challenges such as clogging. In some embodiments, the tool implements a method or system for initiating an unclogging sequence. The tool's controller can be configured to detect a stall event at a drive motor, which can occur when the fan assembly is blocked by debris. A stall event can be detected by, for example, monitoring the Back-EMF current of the motor or by detecting a sudden drop in the rotational speed of the fan assembly. Upon detecting a stall, the system may require a specific user action before initiating the unclogging sequence. For example, the user may need to cycle an operational input, such as by releasing and then re-engaging a trigger on a user interface. In response to detecting the stall and the subsequent user input, the controller can initiate the unclogging sequence. This sequence can involve directing the drive motor to rotate in a second, reverse direction, opposite a normal first direction of rotation. The reverse rotation can be continuous, or it may involve alternating the motor's rotation between the second (reverse) and first (forward) directions to help dislodge the clog. The unclogging sequence may continue until the clog is cleared, which can be determined when a stall absence is detected (e.g., motor current or speed returns to a normal range), or it may be halted if the user releases the trigger or provides another disengagement input.

Additionally or alternatively, the mulching vacuum may be operated using a hybrid closed-loop control system that can toggle between power regulation and speed regulation to affect performance or enhance safety. This system can be managed by a controller in communication with a user interface and the drive motor. During normal, typical, or default operation, the tool can operate in a power control mode. In this mode, the controller may receive an operational input from the user (e.g., at the trigger or user interface, generally) to signal activation or establishing a power target for the drive motor. The power target can be variable, such as corresponding to the degree of trigger pull. Additionally or alternatively, the power target may be capped at a maximum value (e.g., 800 watts). The controller can monitor the actual power draw (e.g., calculated from battery voltage and current) and use a control algorithm, such as a Bounded PI controller, to adjust the motor's pulse-width modulation (PWM) signal to maintain the output power at or near the power target.

While operating in this power control mode, the system can simultaneously monitor the drive motor's rotational speed. In some conditions, such as if the tool is operating under a light load or no load, existing designs risk having a motor over-speed. In aspects of the present disclosure, a controller can determine if the detected rotational speed fails a predetermined speed threshold, for instance, by exceeding a maximum value (e.g., 14,000 RPM) for a set duration (e.g., 200 milliseconds). If this threshold is breached, the controller can direct the tool to transition to a speed control mode. In the speed control mode, the system can regulate the drive motor to maintain a specific speed target, such as 14,000 RPM within a certain tolerance (e.g., +/−5%), regardless of the user's trigger input. Notably, the drive motor or fan assembly from damage due to excessive speed. Optionally, the system may remain in speed control mode until the physical load on the tool increases again. The controller can continue to monitor the power draw, and if it detects that the power draw meets a predetermined power condition—for example, if it rises to meet or exceed the original power target plus a hysteresis value (e.g., 10 watts)—it can determine that the tool is again under sufficient load. In response, the controller can direct the motor to transition back to the power control mode, returning to a state where output power corresponds to the user's demand.

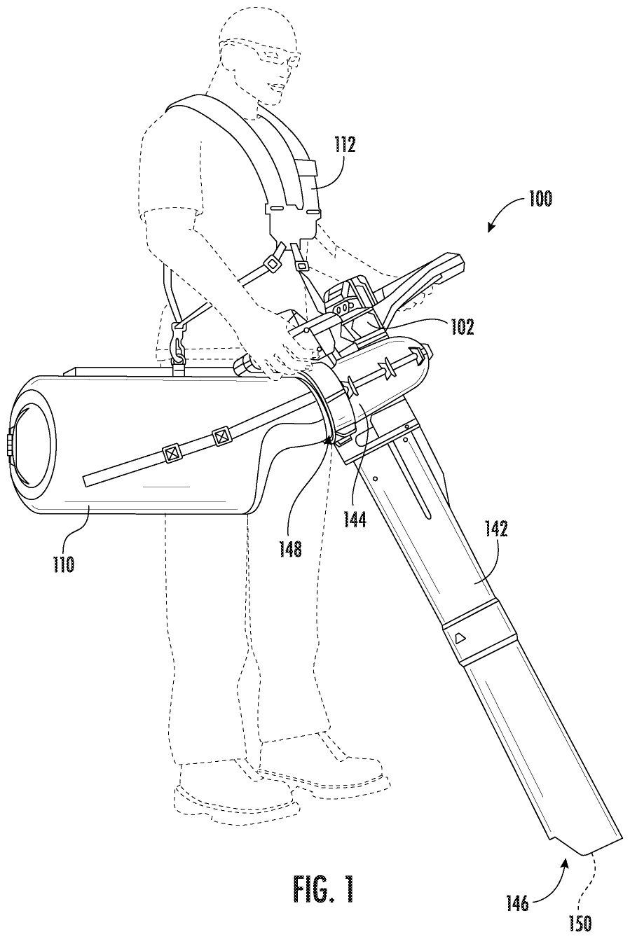

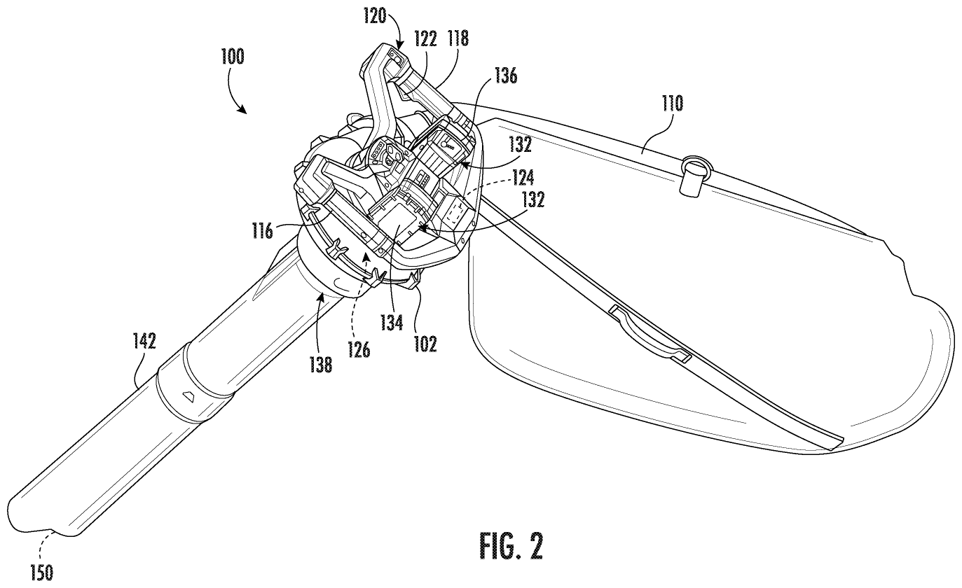

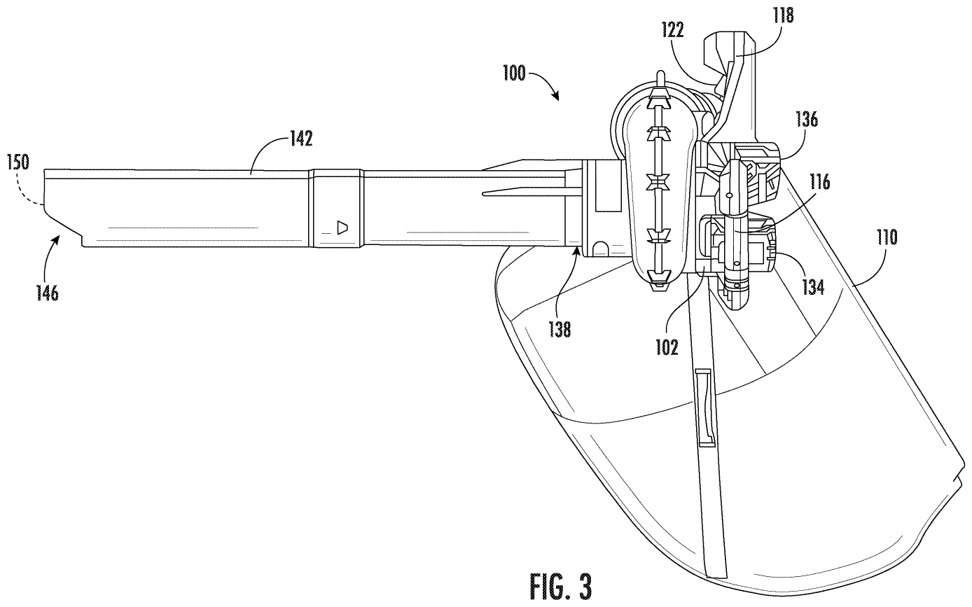

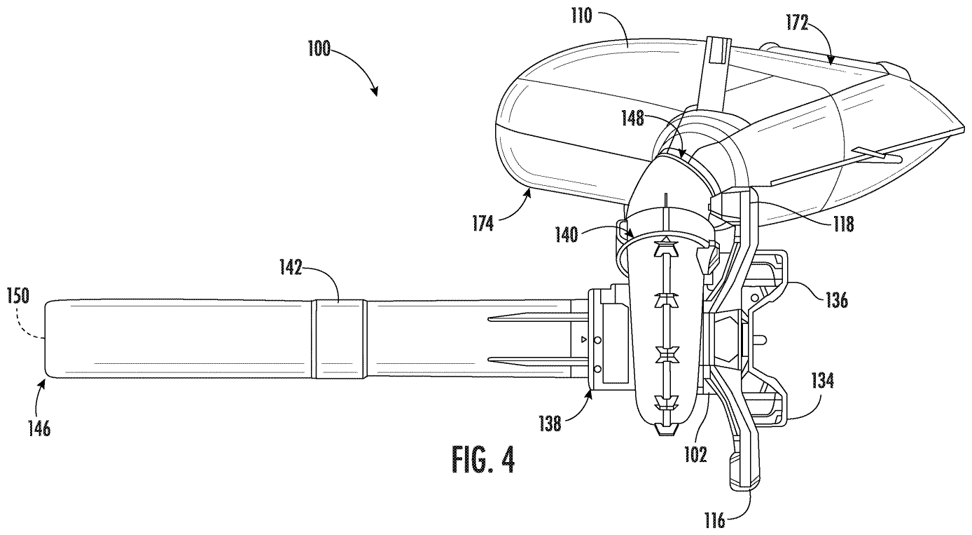

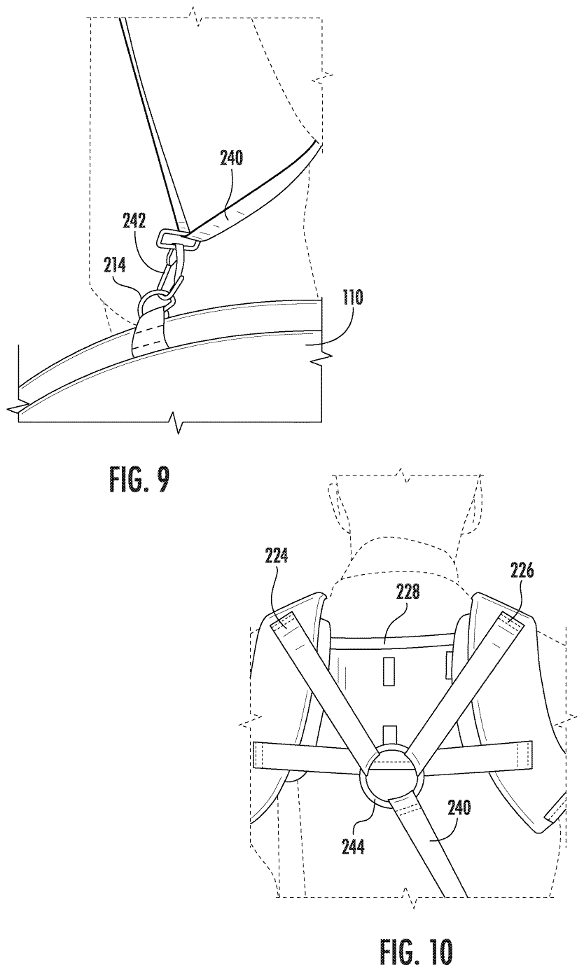

Referring now to the drawings, FIG. 1 through 12 illustrates various views of a mulching vacuum tool 100, in accordance with exemplary embodiments of the present disclosure. As shown, and as will be described in greater detail below, the mulching vacuum tool 100 may include a tool unit 102, debris collection container 110, or harness 112 for supporting the tool unit 102 or debris collection container 110.

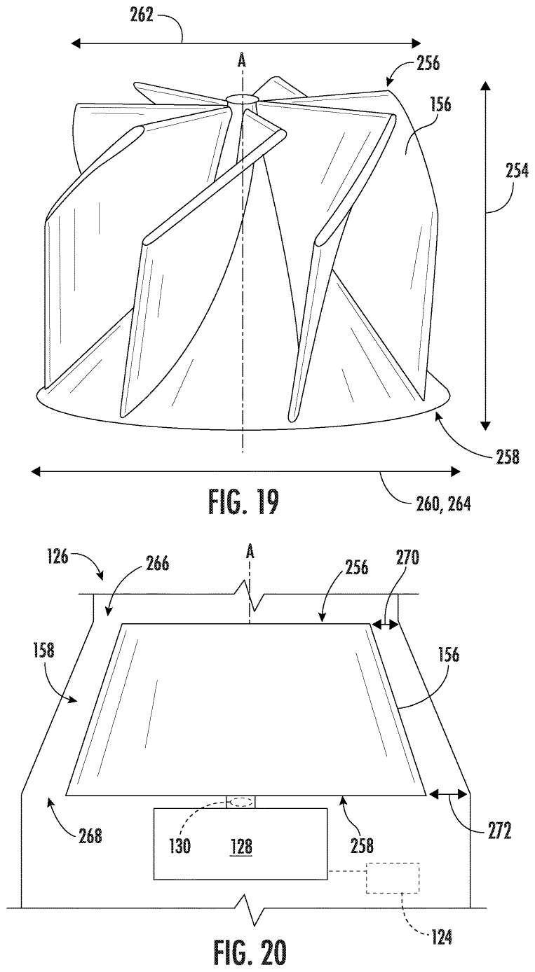

The mulching vacuum tool 100 (e.g., tool unit 102) includes a housing 114. One or more handles 116, 118, may extend from the housing 114. A user interface 120 may further be provided on the housing 114 (e.g., on or proximal to the handle(s) 110, 115) and may provide one or more input elements (e.g., buttons, trigger 122s, switches, etc.) for an operator to engage with to control the tool 100. For instance, the user interface 120 may include a trigger 122 disposed in or on the second handle 118 115. The trigger 122 may be in operable (e.g., electrical or wireless) communication with a controller 124 and generally configured to cause operation of the mulching vacuum tool 100 when actuated by an operator. For instance, the trigger 122 may be configured to activate a drive motor 128 or fan assembly 126 (FIG. 20) disposed in the housing 114. Optionally, the trigger 122 may include variable speed selectivity, allowing the operator to variably control the power of the mulching vacuum tool 100 within a preset range of speeds. For instance, as would be understood, a potentiometer may be connected to the trigger 122 to detect a position or amount of engagement at the trigger 122 (e.g., trigger pull).

In some embodiments, a controller 124 may be provided (e.g., on or within the housing 114) in operable (e.g., electrical or wireless) communication with one or more components of the mulching tool vacuum 100 (e.g., fan assembly 126, user interface 120, etc.). The controller 124 may include a memory and one or more microprocessors, CPUs or the like, such as general or special purpose microprocessors operable to execute programming instructions or micro-control code associated with operation of mulching vacuum tool 100. The memory may represent random access memory such as DRAM, or read only memory such as ROM or FLASH. In some embodiments, the processor executes non-transitory programming instructions stored in memory. For certain embodiments, the instructions include a software package configured to operate mulching vacuum tool 100 or execute an operation routine (e.g., the exemplary method 500, 600, or 700 described below). The memory may be a separate component from the processor or may be included onboard within the processor. Alternatively, controller 124 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

Controller may be positioned in a variety of locations throughout mulching vacuum tool 100. Input/output (“I/O”) signals may be routed between controller 124 and various operational components of mulching vacuum tool 100. One or more components of mulching vacuum tool 100 may be in operative communication (e.g., electric communication) with controller 124 via one or more conductive signal lines or shared communication busses.

Optionally, one or more sensors may be provided in operable communication with the controller 124. In particular, one or more speed sensors 130 may be mounted within the housing 114 to detect (e.g., directly or indirectly) the rotational speed of the flow impeller 156 or drive motor 128. For instance, the rotational speed of the impeller may be determined directly (e.g., by placing a sensor directly on the impeller or impeller shaft) or indirectly by detecting the rotational speed at the drive motor 128. Such speed sensors 130 are generally understood any may include one or more magnetic (e.g., Hall-effect) sensors, optical sensors (e.g., optical encoders), inductive/variable reluctance sensors, etc. Additionally or alternatively, the controller 124 may include a Back-Electromotive Force (Back-EMF) detection circuit to measure voltages the Back-EMF voltage generated during rotation of the drive motor 128.

In exemplary embodiments, the housing 114 defines a battery receiving area 132. One or more battery packs 134, 136 may be removably connected to the mulching vacuum tool 100 at the battery receiving area 132 to power the mulching vacuum tool 100, and specifically the drive motor 128 thereof. The battery receiving area 132 may, for example, provide an electrical connection between the battery and the drive motor 128.

Generally, the housing 114 of the mulching vacuum tool 100 defines an inlet 138 and an outlet 140. The mulching vacuum tool 100 may include an inlet nozzle 142 removably coupled to the inlet 138 and an outlet nozzle 144 removably coupled to the outlet 140. When assembled, the mulching vacuum tool 100 defines an airflow path from an inlet end 146 to an outlet end 148 opposite the inlet end 146. For example, the inlet nozzle 142 may define an intake at the inlet end 146 and the outlet nozzle 144 defines an exhaust at the outlet end 148 such that the airflow path flows through the inlet nozzle 142, the housing 114, and the outlet nozzle 144 in serial flow order. More specifically, the mulching vacuum tool 100 may be configured to collect leaves or other debris through the inlet nozzle 142, the housing 114, and the outlet nozzle 144. For example, the debris may include leaves, grass, or other plant material. Although not shown, the mulching vacuum tool 100 may include a debris collection container 110, such as a collection container 110, removably coupled to the outlet nozzle 144 for collecting the leaves or other debris.

In certain embodiments, a longitudinal axis 150 extends through the mulching vacuum tool 100. The inlet nozzle 142 extends coaxially along (such as parallel with) the longitudinal axis 150. As shown, at least a portion of the outlet nozzle 144 may extend in a direction other than coaxially along or parallel with the longitudinal axis 150. For example, at least a portion of the outlet nozzle 144 may extend perpendicular to the longitudinal axis 150. In such example embodiment, the outlet nozzle 144 may include a curvilinear portion 152 which extends along a curvilinear path relative to the longitudinal axis 150. Turning briefly to FIG. 15, an interior surface of the curvilinear portion 152 may include one or more internal ribs 154 extending within the curvilinear portion. In particular, the internal ribs 154 may extend along at least a portion of the curvilinear path for airflow. For instance, at least one internal rib 154 may extend (e.g., continuously) along the outer radius of the internal surface of the curvilinear portion (e.g., as shown). Optionally, a plurality of internal ribs 154 may be spaced apart from each other (e.g., circumferentially or otherwise in parallel). Such internal ribs 154 may provide an elevated ridge or crest IEC and to create a barrier that can prevent a standardized safety test probe, such as an IEC probe, from reaching a fan assembly 126 through the outlet nozzle 144.

Returning generally to FIGS. 1 through 12, a fan assembly 126 including a flow impeller 156 (FIG. 20) may be disposed in the housing 114. A drive motor 128 (FIG. 20) may be operably coupled to the fan assembly 126 for causing rotation of the fan assembly 126 during operation. For example, the drive motor 128 may cause rotation of the fan assembly 126 upon actuation of a user input element (e.g., trigger 122) by the operator. In at least one example embodiment, the housing 114 defines an impeller chamber 158 enclosing at least a portion of the fan assembly 126. The impeller chamber 158 is in fluid communication with the inlet nozzle 142 and the outlet nozzle 144 and forms at least a portion of the airflow path. Accordingly, the fan assembly 126 is downstream of the inlet nozzle 142 and upstream of the outlet nozzle 144 in the direction of the airflow path.

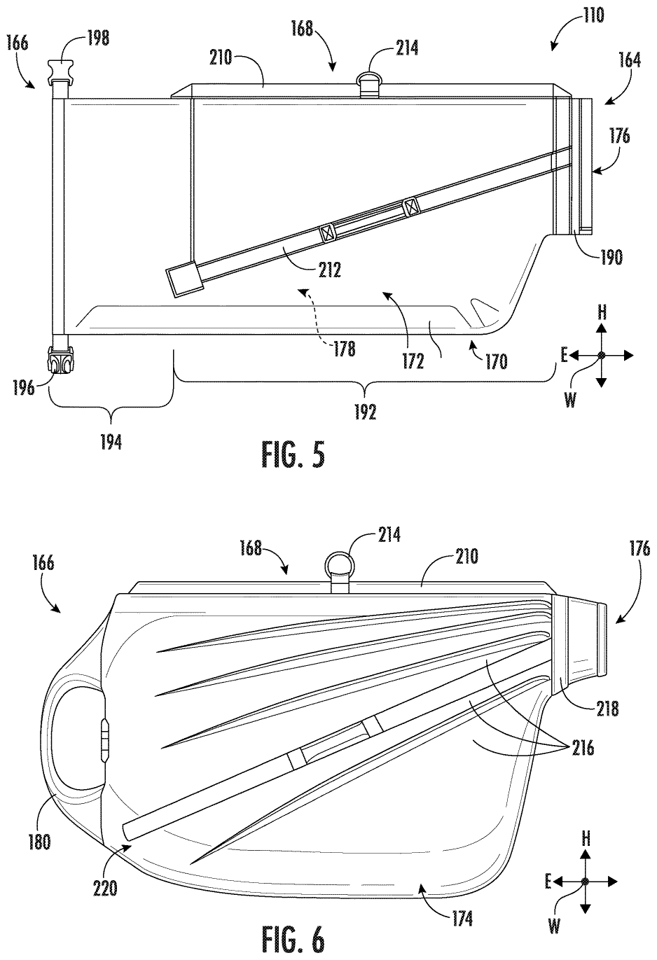

Turning now especially to FIGS. 5 through 10, various aspects of the debris collection container 110 will now be described. Generally, debris collection container 110 defines a plurality of mutually orthogonal direction. In particular, the debris collection container 110 defines a mutually orthogonal length direction E, height direction H, and width direction W. A fabric body 162 (e.g., formed from a prorogated or stitched fabric of any suitable flexible fabric material, such as nylon) extends along the length direction E between a front end 164 and a rear end 166, along the height direction between a top end 168 and a bottom end 170, and along the width direction W between a first lateral end 172 and a second lateral end 174. Between the defined ends, the fabric body 162 defines at least an inlet opening 176, a bag cavity 178, and an outlet opening 180. As will be described in greater detail below, the debris collection container 110 may thus be attached to the tool unit 102 such that debris may flow from the tool unit 102 (e.g., at the outlet nozzle 144) and through the inlet opening 176 into the bag cavity 178. Debris may be subsequently held within the bag cavity 178 before exiting the collection container 110 (e.g., as directed by the user opening the bag) through the outlet opening 180.

As noted, the fabric body 162 may define an inlet opening 176 through which leaves or other debris may be received. In some embodiments, the inlet opening 176 is defined at the front end 164 (e.g., opposite the rear end 166 or outlet opening 180). The inlet opening 176 may be defined as a generally circular opening to be mated to or received on the outlet nozzle 144 (FIG. 1). For instance, the inlet opening 176 may fit over and receive at least a portion of the outlet nozzle 144. The inlet opening 176 may be removably coupled to the outlet nozzle 144 by a threaded engagement or a non-threaded engagement, a bayonet connection, a nonthreaded connector such as one or more pin(s), a clasp, rotatable lever, a latch, zipper or any combination thereof.

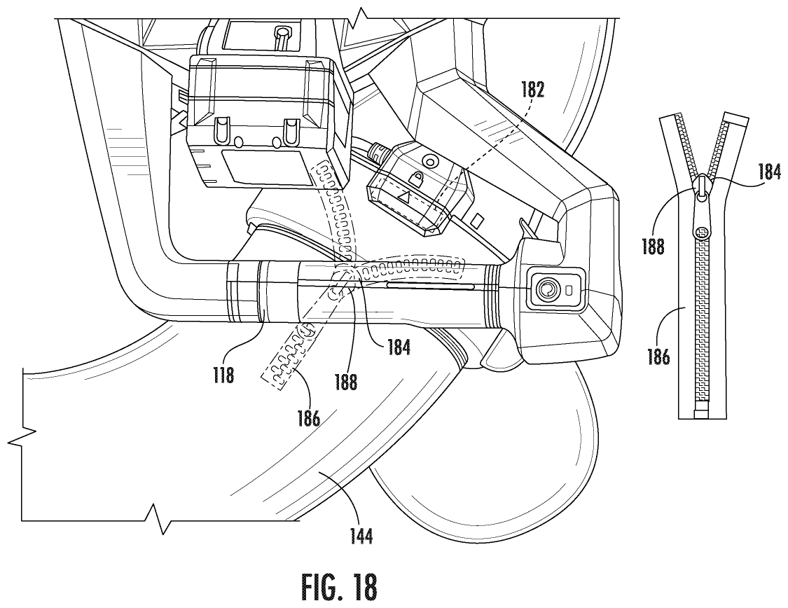

Turning briefly to FIG. 18, one or more nozzle sensors 182 may be provided in operable communication with the fan assembly 126 (e.g., directly or indirectly via a controller 124). The nozzle sensor 182 may be configured to detect the debris collection container 110 in an attached position (e.g., secured on the outlet nozzle 144) and permit activation of the fan assembly 126 (e.g., at the drive motor 128) in response to detecting the debris container in the attached position. Thus, the fan assembly 126 may be electronically prevented from activating or rotate unless or until the nozzle sensor 182 receives one or more signals indicating the debris collection container 110 is in the attached position.

In some such embodiments, the nozzle sensor 182 includes an electric field sensor, such Hall effect sensor or RFID reader (e.g., mounted on or proximal to the outlet nozzle 144). The debris collection container 110 or outlet nozzle 144 may include a detectable tag 184 (e.g., magnet or RFID tag) in selective (e.g., magnetic or radio-frequency) communication with the electric field sensor at the attached position. In some such embodiments, the debris collection container 110 or outlet nozzle 144 may include a coupling zipper 186 at or along the inlet opening 176 and which holds or is in mechanical communication with the detectable tag 184 to bring the detectable tag 184 into alignment with the nozzle sensor 182 (e.g., when fully closed or zipped). Thus, the nozzle sensor 182 may only permit the fan assembly 126 to activate when the zipper halves are closed. Optionally, the coupling zipper 186 includes a top portion that joins together to form a buckle or other suitable joint permitting the detectable element to be aligned with or joined to the outlet nozzle 144 or housing 114. Thus, when the top of the coupling zipper 186 stops at the top portion or fully closed position, the coupling zipper 186 forms a buckle that engages with a receiver to position the detectable element in place relative to the outlet nozzle 144 or housing 114. Additionally or alternatively, the detectable tag 184 may be mounted on the zipper slider 188 (e.g., to move therewith) and positioned to be aligned with the nozzle sensor 182. Thus, when the container zipper is opened, the open container zipper may block the nozzle sensor 182; yet when the container zipper is closed (i.e., in the attached position), the container zipper may align with the nozzle sensor 182 and thereby permit activation of the fan assembly 126.

Returning now to FIGS. 5 through 10, in certain embodiments, a rigid collar 190 is joined to the fabric body 162 at the inlet opening 176 to maintain a predefined shape (e.g., matched or complementary to the outlet nozzle 144). In some such embodiments, the rigid collar 190 is embedded within the fabric body 162. However, additional or alternative embodiments can include another joint, sewn pocket, or adhesive to fix the rigid collar 190 relative to the fabric body 162.

The bag cavity 178 may be defined within the collection container 110. In particular, the bag cavity 178 may be defined within a storage portion 192 of the collection container 110. As shown, the portion may be provided between the inlet opening 176 and the outlet opening 180. For instance, along the length direction E, the storage portion 192 may be disposed between the inlet opening 176 (e.g., at or proximal to the front end 164) and the outlet opening 180 (e.g., at or proximal to the rear end 166).

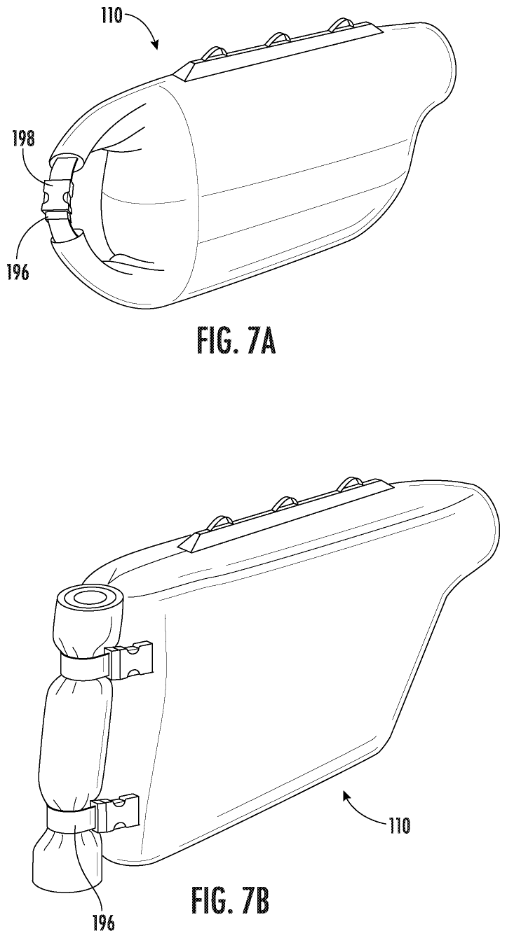

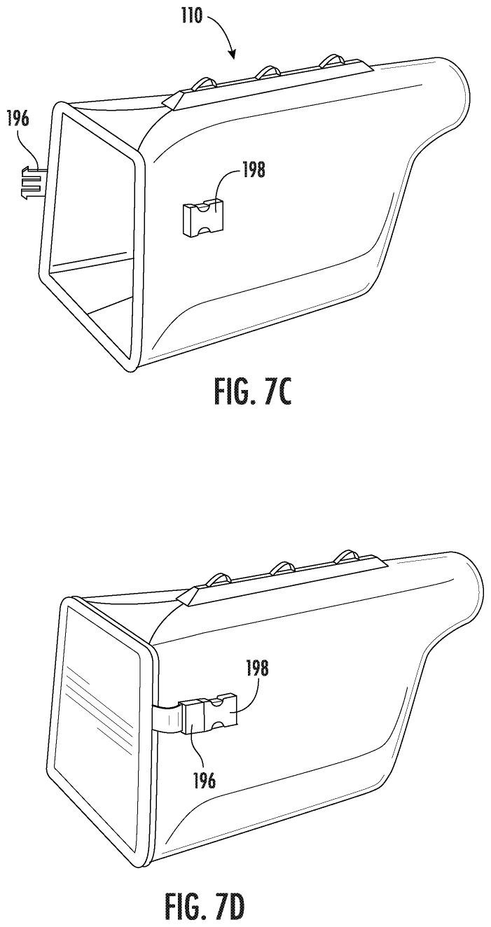

At or proximal to the outlet opening 180, the fabric body 162 includes a foldable closing portion 194. For instance, the foldable closing portion 194 may extend (e.g., forward) from the outlet opening 180. The foldable closing portion 194 may terminate at the storage portion 192. Generally, the foldable closing portion 194 provides a section of the fabric body 162 that can be selectively folded in on itself to close or seal the outlet opening 180. Specifically, the foldable closing portion 194 may be movable between folded-closed position (e.g., FIGS. 7A and 7B, wherein the outlet opening 180 is blocked closed by the foldable closing portion 194) and an unfolded position (e.g., FIG. 5, wherein the outlet opening 180 is uncovered to permit the flow of debris therefrom). It is noted that FIG. 7C and FIG. 7D further illustrate the transition between an unfolded position and a folded-closed position according to exemplary embodiments.

In exemplary embodiments, one or more clasps 444, 446 may be provided on the fabric body 162 to selectively hold the foldable closing portion 194 in the folded-closed position. For instance, a bag clasp 196 (e.g., mechanical clip, elastic loop, latch, catch, hook-and-loop fastener half, snap-fit button, etc.) may be attached to the fabric body 162 at the foldable closing portion 194. As shown, the bag clasp 196 may be spaced apart from the outlet opening 180. As the foldable closing portion 194 is moved to the folded-closed position, the outlet opening 180 or rear end 166 of the collection container 110 may, in turn, be moved closer to the bag clasp 196. By contrast, as the foldable closing portion 194 is moved to the unfolded-opened position, the outlet opening 180 or rear end 166 may be moved farther from the bag clasp 196.

In addition to the bag clasp 196, some embodiments include a secondary clasp 198 that is configured to engage with the bag clasp 196 (e.g., in a male-female clip connection). Thus, the secondary clasp 198 may be provided on the fabric body 162 to engage the bag clasp 196 in a mated connection. Specifically, a secondary clasp 198 may be attached to the fabric body 162 in selective connection with the bag clasp 196 at the foldable closing portion 194. The secondary clasp 198 may be a complementary connector to the bag clasp 196 and, thus, may include or be provided as any suitable mechanical clip, elastic loop, latch, catch, hook-and-loop fastener half, snap-fit button, etc.). The secondary clasp 198 may be the male clip to the female clip of the bag clasp 196 (e.g., as illustrated), or vice versa.

As shown, for instance in FIGS. 5 and 7A, secondary clasp 198 may be disposed above bag clasp 196 (e.g., along a common portion of the length E). However, in alternative embodiments, such as those shown between FIGS. 7B, 7C, and 7D, the secondary clasp 198 is disposed between the outlet opening 180 and the bag clasp 196. In the illustrated embodiments, the secondary clasp 198 is disposed between the outlet opening 180 and the bag clasp 196 along the length direction E.

It is noted that, although a single bag clasp 196 and secondary clasp 198 are described, it is understood that multiple bag clasp-secondary clasp pairs 444-446 may be provided (e.g. as illustrated in FIG. 7B) to hold the collection container 110 at multiple points in the folded-closed position).

As shown, especially in FIG. 5, one or more batten panels 210 or 212 may be joined to the fabric body 162. Generally, each batten panel 210 or 212 may provide a semi-rigid (e.g., planar) panel or strip. For instance, one or more batten panels may be formed from a flexible polymer or plastic. When assembled, each batten panel may be joined to (e.g., affixed or embedded within) the fabric body 162. For instance, a batten panel 210 or 212 may be sewn or sealed within a pocket or sleeve of the fabric body 162 (e.g., outside of or apart from the bag cavity 178). In some embodiments, an upper batten panel 210 is joined to the fabric body 162 at a top portion of the container 110. The upper batten panel 210 may be disposed above the bag cavity 178. Additionally or alternatively, the upper batten panel 210 may be disposed along the storage portion 192. Optionally, a harness anchor 214 may be joined to this upper batten panel 210, providing a connection point for a hook or clasp from the user harness 112.

Separately from or in addition to an upper batten panel 210, a upper batten panel 212 may be joined to the fabric body 162 (e.g., at a sidewall segment of the debris collection container 110). In some embodiments, the upper batten panel 212 is positioned laterally outward from the container cavity. Optionally, the upper batten panel 212 may be disposed below the upper batten panel 210 (e.g., at a lower relative height).

Turning especially to FIG. 6, the fabric body 162 may define one or more expansion pleats 216. Generally, the expansion pleats 216 may include or be provided as folds in the fabric body 162 that are expandable (e.g., in response to airflow or pressure within the bag cavity 178) to increase the effective surface area of the debris collection container 110 (e.g., without significantly increasing its overall volume). One or more expansion pleats 216 may be spaced apart (e.g., along the height direction H). Additionally or alternatively, one or more expansion pleats 216 may extend from a tucked end 218 (e.g., pinned, sewn, or adhered to an adjacent portion of the fabric body 162) to an untucked end 220 (e.g., unsewn or otherwise expandable). Optionally, such expansion pleats 216 may extend generally along the length direction E such that the tucked end 218 is located proximal to the inlet opening while the untucked end 220 is located distal to the inlet opening (e.g., proximal to the outlet opening).

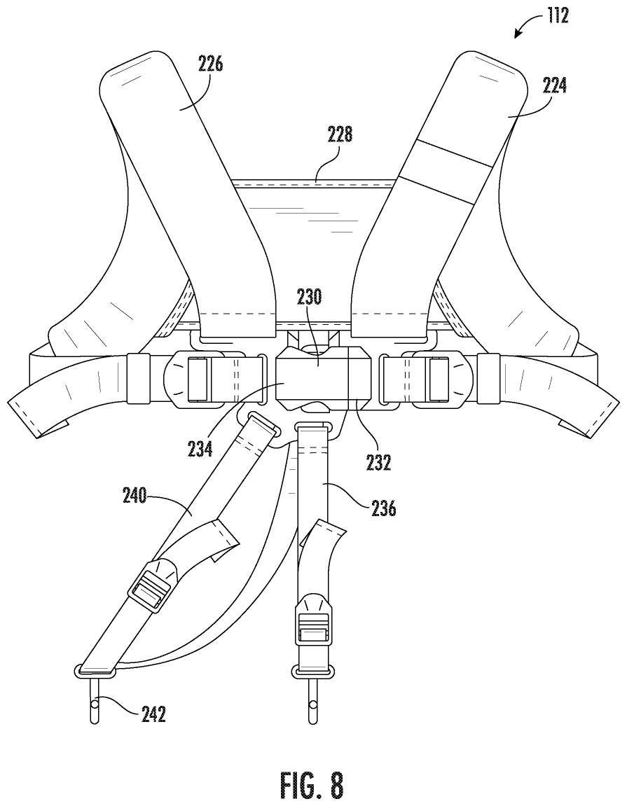

Turning now especially to FIGS. 8 through 10, as well as FIG. 1, a user harness 112 may be provided to be worn by an operator and selectively attached to the tool unit 102 or debris collection container 110 for additional support and weight distribution. Generally, the user harness 112 may be provided as a “backpack” style including two shoulder straps 224, 226 (e.g., a left shoulder strap 224 and a right shoulder strap 226) each extending from a position behind an operator and over the operator's arm or shoulder. Optionally, a back panel 228 (e.g., formed from or including of a breathable or padded material) may join the left and right shoulder straps 224, 226 at a rear portion of the harness 112, such as to distribute weight between the shoulder straps 224, 226 or otherwise maintain a relative position thereof at the rear portion of the harness 112. In some such embodiments, the back panel 228 includes or is provided as an elastic back support element, thereby allowing selective expansion and contraction of the back panel 228 to (e.g., allowing the back panel 228 to conform to the user's body and distribute weight across the shoulders and back of the operator).

At a front portion of the harness 112, a front connection panel 230 may selectively join the left and right shoulder straps 224, 226. For example, the front connection panel 230 may include a right clasp 234 on the right shoulder strap 226 and a left clasp 232 on the left shoulder strap 224. The right clasp 234 and the left clasp 232 may be provided as any suitable mating pair (e.g., mechanical clips, snaps, ties, etc.). In turn, the right and left clasps 232, 234 may be selectively attached to each other, connecting the front portions of the left and right shoulder straps 224, 226.

In optional embodiments, a central anchor strap 236 is provided at a front portion of the user harness 112 (e.g., on the front connection panel 230) in selective connection with the housing 114. For instance, the central anchor strap 236 may extend from one of the right clasp 234 or the left clasp 232 (e.g., either from the right clasp 234 or from the left clasp 232). During use, the central anchor strap 236 may be disposed between the left and right shoulder straps 224, 226. Additionally or alternatively, the central anchor strap 236 may provide a clip, tie, or other mechanical anchor attachment to selectively to the housing 114. Optionally, a central anchor mount 238 may be provided on the housing 114 of the tool unit 102 (e.g., between a first and second handle 118) to serve as a connection point for the central anchor strap 236 of the user harness 112. Thus, the central anchor strap 236 may be joined to and position the tool unit 102 tool centrally in front of the user.

In certain embodiments, the user harness 112 is able to (e.g., selectively) support the debris collection container 110. For instance, the user harness 112 may include a side anchor strap 240 having a container anchor 242 supported thereon to connect to the debris container and, thereby, distribute at least a portion of the weight of the debris collection container 110 to the user harness 112. As shown, the side anchor strap 240 may extend from the back panel 228 or rear portion of the user harness 112 generally. Optionally, a rear anchor 244 may be disposed between the left shoulder strap 224 and the right shoulder strap 226 at the rear portion of the user harness 112 and connect to the side anchor strap 240. In some embodiments, the side anchor strap 240 extends between the rear and front portions of the user harness 112. For instance, the side anchor strap 240 may extend from the rear anchor 244, run along the side of the user harness 112 or operator, and connect to the front connection panel 230. In optional embodiments, the container anchor 242 is slidably disposed on the side anchor strap 240, notably allowing the user to adjust the position of the container for comfort or balance as it fills with debris.

As noted above, some or all strap adjustments may be located at the front of the harness 112, notably allowing the user to make changes without removing the tool or harness 112. The attachment points for the tool unit 102 and container 110 can be grouped on one side, for example the right side, such that when the harness 112 is unbuckled, an operator can put on or take off the entire mulching vacuum tool 100 (e.g., in a manner similar to a jacket).

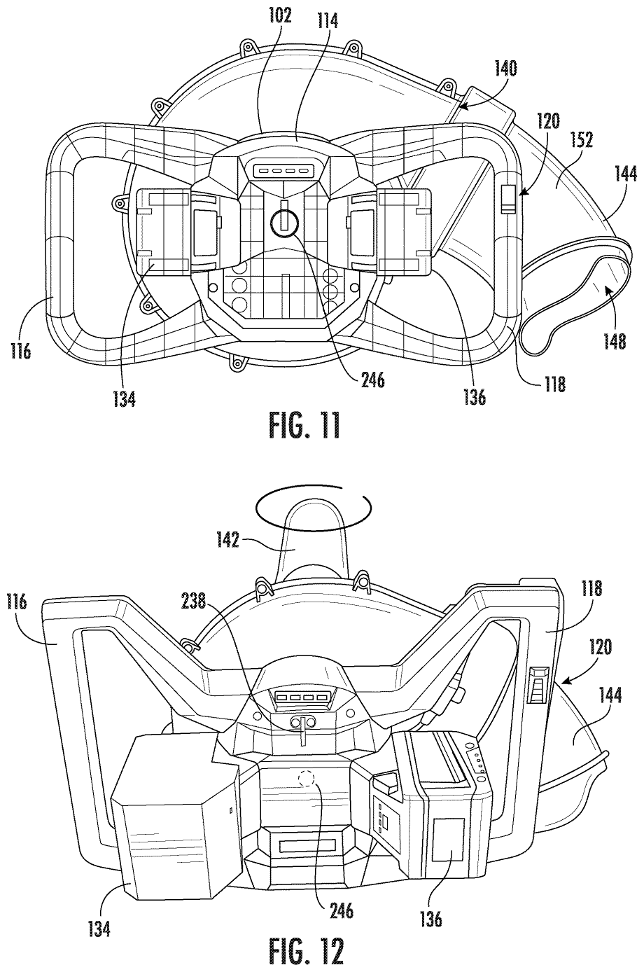

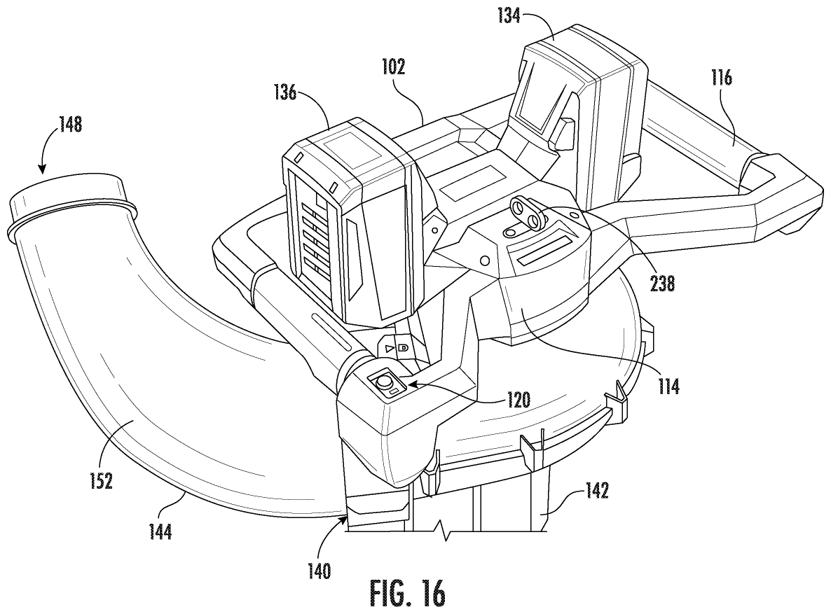

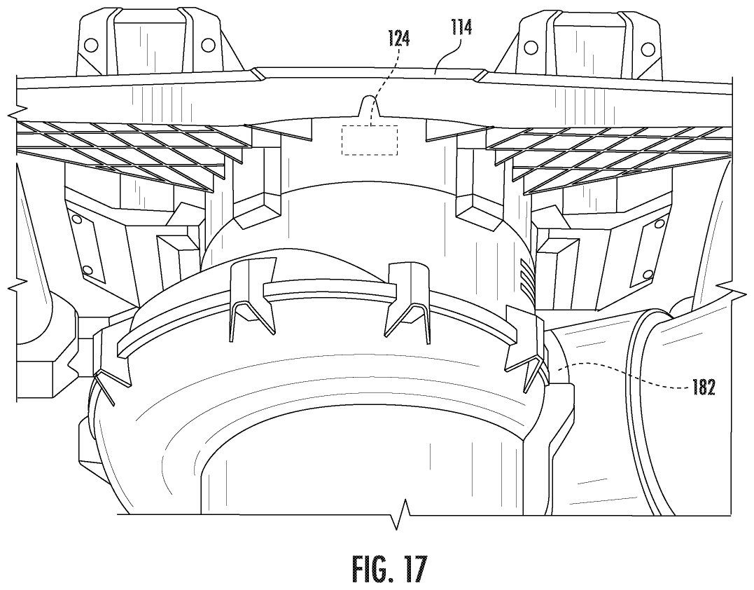

Turning now to FIGS. 11 and 12, as well as FIG. 16, various views are provided of the tool unit 102. As noted above, the mulching vacuum tool 100 can be powered by one or more batteries, such as a plurality or pair of batteries including a first battery pack 134 and a second battery pack 136 separately supported on the housing 114. When assembled, the tool unit 102 (e.g., including the pair of batteries, the fan assembly 126, and the housing 114) define a center of gravity 246. As shown, the center of gravity 246 may be located between the first and second handles 116, 118. Optionally, the two battery packs 134, 136 may be spaced (e.g., radially) equidistant from the center of gravity 246. Moreover, the center of gravity 246 may be located within a volume defined by the two battery packs 134, 136 and the space between them.

In certain embodiments, the first handle 116 and second handle 118 can extend radially outward from a main body of the housing 114 (e.g., in opposite directions relative to the left and right of the housing 114). In some embodiments, the handles 116, 118 wrap around or radially border the battery packs 134, 136. Thus, the battery packs 134, 136 may each be disposed radially inward from the first and second handles 116, 118. The handles 116, 118 may notably provide a protective cage for the packs 134, 136 against drop damage or impacts. The handles 116, 118 may be positioned forward of the batteries, such as closer to the inlet nozzle 142. Optionally, the central anchor mount 238 supported on the housing 114 between the first handle 116 and the second handle 118 (e.g., to selectively connect with the central anchor strap 236 of a harness 112). Advantageously, the handles 116, 118 may provide a suitable balance or allow the user to maintain a comfortable in-use nozzle angle and a line of sight to a work piece or a tip of the inlet nozzle 142.

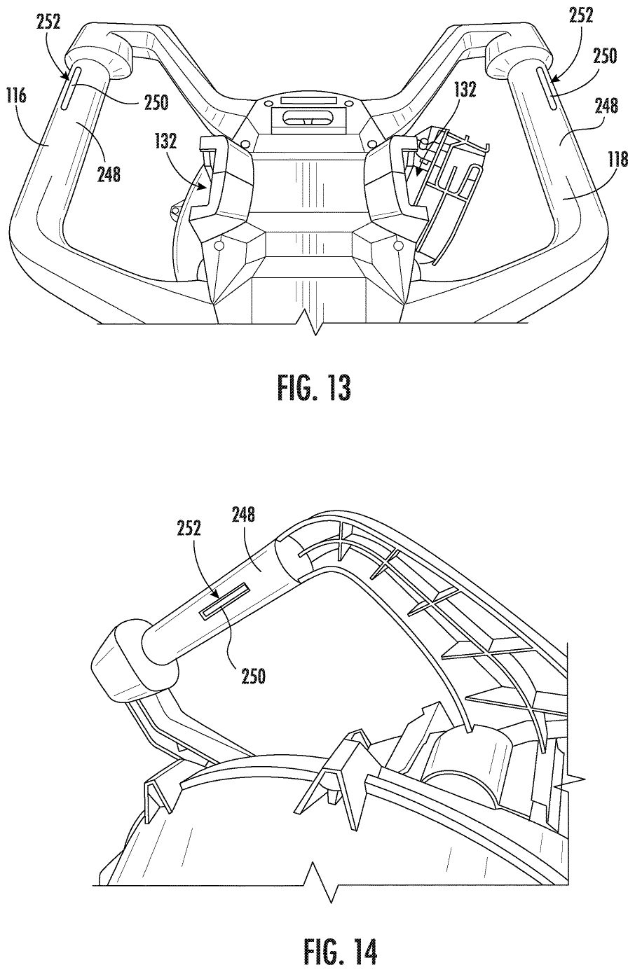

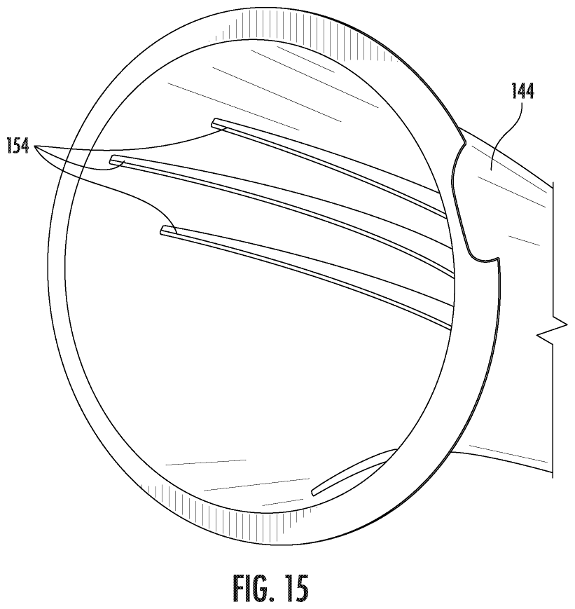

Turning now to FIGS. 13 and 14, the first and second handles 116, 118 generally include a grip body 248. In some embodiments, one or both of the first and second handle 118 includes a contact wire 250 supported on the corresponding grip body 248. When assembled, the contact wire 250 may be exposed to contact an operator's hand. For instance, an aperture 252 may be defined through the grip body 248 to expose the contact wire 250, which may be disposed behind or beneath the aperture 252. Optionally, the contact wire 250 protrudes through both the top and bottom (e.g., front and back as viewed by the operator) of a corresponding handle, creating multiple points of contact to facilitate grounding with the operator's hands. In some such embodiments, separate apertures 252 are provided at both the top and bottom of the corresponding handle.

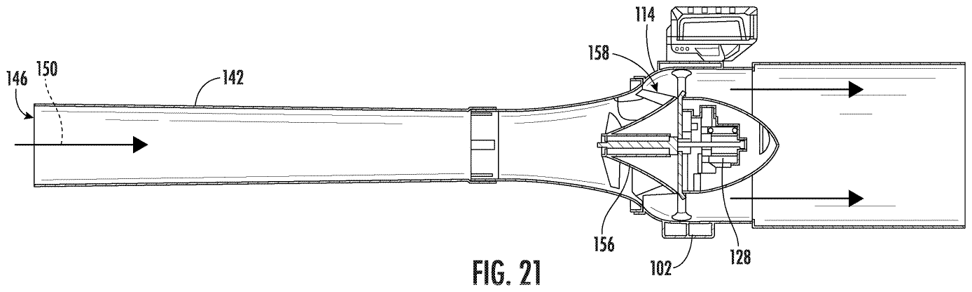

Turning now to FIGS. 20 and 21, in some embodiments, the fan impeller is provided as or includes a mixed-flow impeller 156, operable to motivate an airflow thereacross along an airflow path that extends both axially and radially (e.g., with both axial and centrifugal fan characteristics). As shown, the mixed-flow impeller 156 defines an axial height 254 (e.g., between a forward or intake end 256 and a rearward or exhaust end 258) and a radial diameter 260 (e.g., maximum diameter radially outward from the axial direction A or axis of rotation for the flow impeller 156, which may be parallel to the longitudinal axis 150). In some embodiments, an impeller ratio of the axial height 254 to the radial diameter 260 of between approximately 0.5 and 1.5 (e.g., between 0.5 and 1.5 or between 0.5 and 1.0). At the intake end 256, the mixed-flow impeller 156 may define an intake diameter 262 while at the exhaust end 258 an exhaust diameter 264 is defined. The mixed-flow impeller 156 may generally increase in diameter along the axial direction A. Thus, the exhaust diameter 264 may be greater than the intake diameter 262. For instance, the mixed-flow impeller 156 may define a diameter ratio of the intake diameter 262 to the exhaust diameter 264 of between 0.5 and 0.9 (e.g., between 0.57 and 0.82). Optionally, the exhaust diameter 264 may be between 80 and 160 millimeters. Additionally or alternatively, the axial height 254 may be between 60 and 140 millimeters.

Notably, the mixed-flow impeller 156 may be relatively compact (e.g., in comparison to existing designs) while still generating a suitable airflow through the fan assembly 126.

As shown, the housing 114 may define an impeller chamber 158 within which the flow impeller 156 is enclosed. In particular, the impeller chamber 158 may be in fluid communication between the inlet 138 and outlet 140 (i.e., downstream from the inlet 138 and upstream from the outlet 140). The impeller chamber 158 may include a chamber intake 266 (e.g., at or upstream from a forward end of the flow impeller 156) and a chamber exhaust 268 (e.g., at or downstream from a rearward end of the flow impeller 156).

Generally, a radial clearance dimension is defined between the flow impeller 156 and the interior wall of the impeller chamber 158. In some embodiments, the radial clearance dimension varies (e.g., gradually along the axial direction A between the chamber intake 266 and the chamber exhaust 268). For instance, a first radial clearance value 270 may be defined at the chamber intake 266 while a second radial clearance value 272 may be defined at the chamber exhaust 268 that is different from the first radial clearance value 270. In certain embodiments, the radial clearance increases along the axial direction A (e.g., linearly or exponentially). Thus, the first radial clearance value 270 may be less than the second radial clearance value 272. As an example, the first clearance value may be between 4 and 7 millimeters while the second clearance value is between 6 and 9 millimeters while remaining greater than the first clearance value. Notably, suitable mulching performance may be ensured (e.g., while preventing clogging or permitting easy correction thereof).

As shown, the flow impeller 156 may define an outlet flow that is directed at an angle between 20 degrees and 80 degrees relative to the axial direction A. Notably, consistent tool performance may be maintained under varying loads (e.g., operating in a high RPM range, such as between 5000 and 16000 RPM).

Optionally, and as illustrated at FIG. 21, the housing 114 may feature a voluteless design wherein the chamber intake 266 and the chamber exhaust 268 are substantially axial and parallel to each other (e.g., within +/−5 degrees of parallel). Notably, this may eliminate the need for a large, spiral-shaped volute casing, resulting in a smaller overall package and lower system resistance for increased airflow.

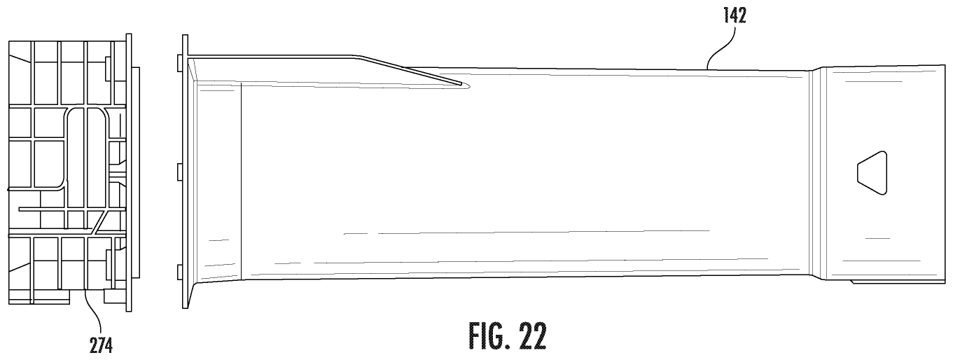

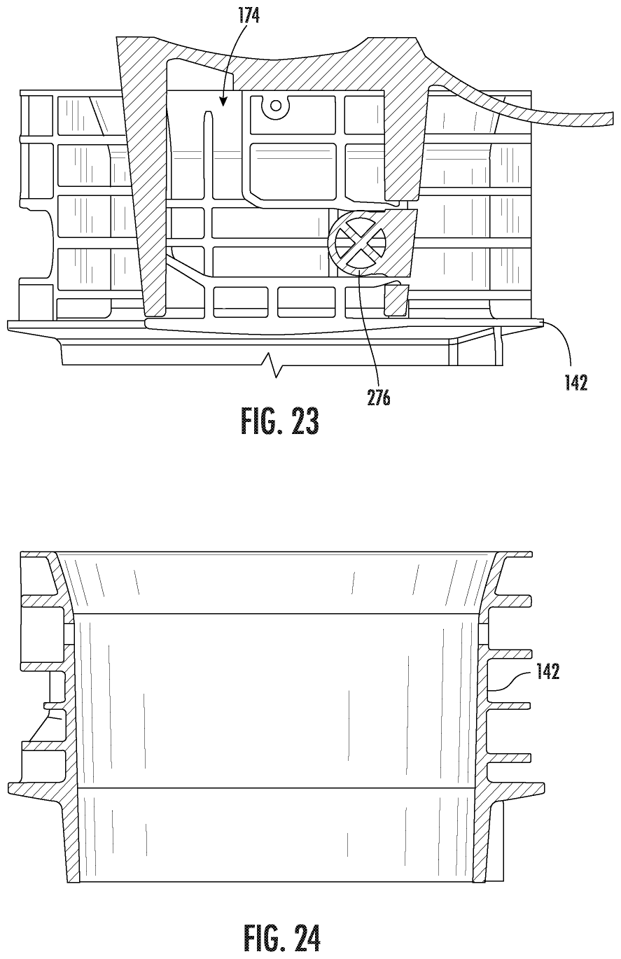

Turning especially to FIGS. 22 through 24, the inlet nozzle 142 may be removably coupled to the inlet 138 of the housing 114 by a bayonet connection (e.g., as illustrated), a threaded engagement, a nonthreaded connector such as one or more pin(s), a clasp, rotatable lever, a latch, or any combination thereof. A selective locking interface may be provided at the inlet nozzle 142. For instance, a tube interface 274 formed between the inlet nozzle 142 and housing 114 and include an axial cam surface or latch 276 for secure connection and preventing debris from escaping. Moreover, a radial locking geometry may communicate to user that tube is installed correctly and retain tube from coming loose during use.

In certain embodiments, the inlet nozzle 142 selectively covers or defines at least a portion of the impeller chamber 158. In turn, when the inlet nozzle 142 is removed from the housing 114, the flow impeller 156 may be at least partially exposed or accessible (e.g., to clear a potential clog). Optionally, the inlet nozzle 142 may have a thicker wall or reinforcement about the region of the inlet nozzle 142 proximal (e.g., along the axial direction A) to the flow impeller 156 when attached to the housing 114. Additionally or alternatively, at least a portion of the inlet nozzle 142 (e.g., proximal to the impeller) may include a shroud insert comprising a separate, relatively high-strength material (e.g., metal or composite) distinct from the rest of the inlet nozzle 142.

Now that the construction of a power tool (e.g., mulching vacuum 100) according to exemplary embodiments have been presented, exemplary methods (e.g., method 500, 600, or 700) of operating a power tool will be described. In exemplary embodiments, the various method steps as disclosed herein may be performed (e.g., in whole or part) by controller 124.

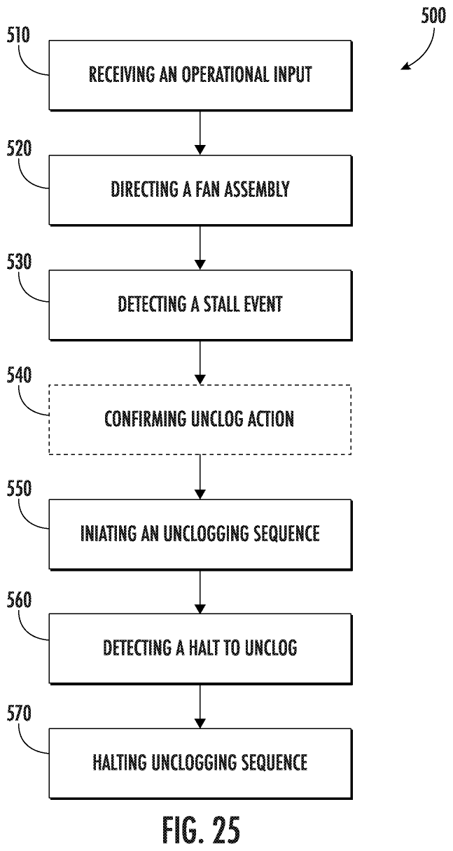

FIGS. 25 through 27 depict steps performed in a particular order for purpose of illustration and discussion. Those of ordinary skill in the art, using the disclosures provided herein and except as otherwise indicated, will understand that the steps of the methods are non-exclusive and can be modified, adapted, rearranged, omitted, interchanged, or expanded in various ways without deviating from the scope of the present disclosure.

Turning now to FIG. 25, at 510, the method 500 includes receiving an operational input from a user interface. Generally, such an operational input may correspond to or otherwise indicate an operator has engaged a portion of the user interface and intends to activate the tool and, specifically, the fan assembly. For instance, 510 may include receiving a signal from the trigger in response to an operator squeezing, moving, or otherwise engaging the same. Thus, the operational input may include or be provided as a signal from the user interface (e.g., trigger) in response to engagement thereof. As noted above, the trigger may be a variable input in which the signal therefrom varies according to the position or extent to which the trigger is engaged or moved. Thus, the operational input may vary according to the position of the trigger (e.g., trigger pull) or other corresponding input element.

At 520, the method 500 includes directing a drive motor of the fan assembly to rotate (e.g., in a first direction). For instance, 520 may be based on or in response to 510. Generally, the rotation of the drive motor may cause the flow impeller of the fan assembly to rotate (e.g., according to normal operational parameters) and generate an airflow from the inlet nozzle and through the outlet nozzle (e.g., to the debris collection container).

At 530, the method 500 includes detecting a stall event at the drive motor. Specifically, 530 may occur while directing the drive motor of the fan assembly to rotate (e.g., at 520). As an example, 530 may include monitoring a Back-EMF current at the drive motor. For instance, a detected spike (e.g., above a predetermined threshold) in back-EMF at the drive motor may correspond to and indicate a stall thereof. As an additional or alternative example, 530 may include monitoring a rotational speed of the fan assembly (e.g., at the flow impeller) in the first direction. For instance, a sudden drop (i.e., reduction) in the rotational speed of the fan assembly may correspond to and indicate a stall thereof. As another additional or alternative example, 530 may include receiving a stall input (e.g., manual indication of stall) at the user interface. For instance, an operator may manually engage a portion of the user interface to provide an input or indication of an operator-detected stall event.

At 540, the method 500 includes, optionally, confirming an unclog action is desired. Thus, 540 may include receiving a confirmation signal that a user intends for the tool to detect remedial action regarding the detected stall. In some embodiments, 540 includes detecting a cycling of the operational input at the user interface (e.g., following 530). For instance, a user may cycle (e.g., release and reengage) the same portion of the user interface as at 510, such as the trigger. In some embodiments, 540 includes detecting disengagement with the user interface (e.g., trigger) following 510, 520, or 530. Disengagement with the user interface may prompt a halting of rotation at the fan assembly (e.g., to halt any motive current or instructions to the drive motor). Subsequently, or following detecting disengagement, 540 may further include detecting reengagement with the user interface (e.g., within a predetermined time period following 530 or detection of disengagement with the user interface). Thus, it may be determined that an operator intended to cease instructions for rotation at the drive motor before prompting a new action.

At 550, the method 500 includes initiating an unclogging sequence at the drive motor (e.g., following or based on at least 530). Optionally, 550 may be in response to 540 (e.g., detecting the cycling the user interface). In some embodiments, 550 includes halting rotation in the first direction. In further embodiments, 550 includes directing the drive motor of the fan assembly to rotate in a second direction opposite the first direction. For instance, if the first direction is counter-clockwise about the axial direction, the second direction may be clockwise about the axial direction. In certain embodiment, the unclogging sequence includes alternating rotation of the drive motor of the fan assembly between the second direction and the first direction. Thus, the drive motor may pulse or switch directions of rotation for the drive motor according to a set schedule, rate, or sequence while the unclogging sequence occurs (e.g., while the user interface remains reengaged). In alternative embodiments, the unclogging sequence includes directing the drive motor of the fan assembly to rotate in a second direction continuously. Thus, the drive motor may rotate exclusively in the second direction (e.g., without halting) while the unclogging sequence occurs (e.g., while the user interface remains reengaged).

At 560, the method 500 includes detecting a halt to the unclog condition (e.g., during or following 550). Generally, 560 corresponds to an indication or determination that the unclogging sequence is no longer desired (e.g., by an operator) or needed (e.g., due to the stall event being resolved). As an example, 560 may include detecting renewed disengagement with the user interface (e.g., following detecting the cycling of the operational input). Thus, after a user cycles the user interface (e.g., trigger) to prompt 550, subsequent release of the user interface or trigger may indicate a desire to halt the unclogging sequence. As an additional or alternative example, 560 may include determining a stall absence during the unclogging sequence. Such a determination may be made, for instance, based on a monitored current or voltage at the drive motor. Additionally or alternatively, a sensor signal may be received (e.g., corresponding to a speed of rotation of the drive motor or flow impeller or an airflow through the housing).

At 570, the method 500 includes halting the unclogging sequence. Specifically, 570 may follow at least 550. In some embodiments, 570 is in response to detecting renewed disengagement with the user interface. At 570, rotation of the flow impeller or drive motor in the second direction may be stopped. Subsequently, the drive motor may be permitted to return to a typical, default, or normal operation, such as to permit rotation of the flow impeller or drive motor in the first direction based on or in response to further engagement with the user interface (e.g., at the trigger).

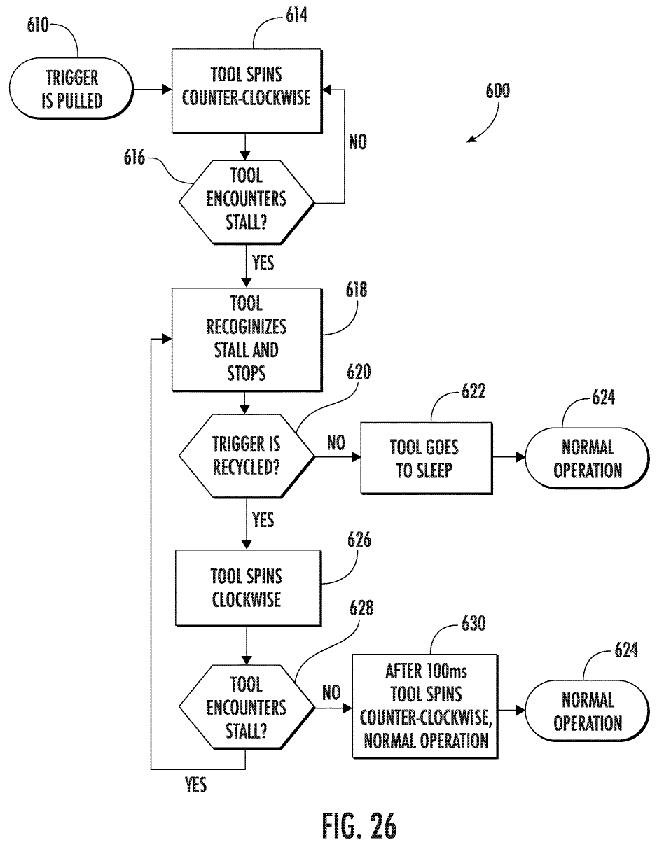

Turning now to FIG. 26, at 610, the method 600 includes detecting a trigger of the tool is pulled (or otherwise engaged). For instance, 610 may include receiving a signal from the trigger in response to an operator squeezing, moving, or otherwise engaging the same. Thus, the detection may include or be provided as a signal from the trigger in response to engagement thereof. As noted above, the trigger may be a variable input in which the signal therefrom varies according to the position or extent to which the trigger is engaged or moved. Thus, the operational input may vary according to the position of the trigger (e.g., trigger pull).

At 614, the method 600 includes rotating the tool (e.g., at the flow impeller or drive motor) counter-clockwise in response to 610. Generally, the rotation of 614 may cause the flow impeller of the fan assembly to rotate (e.g., according to normal operational parameters) and generate an airflow from the inlet nozzle and through the outlet nozzle (e.g., to the debris collection container).

At 616, the method 600 includes determining if a stall has been encountered (e.g., as or as part of a stall event at the drive motor). Specifically, 616 may occur during 614. As an example, 616 may include monitoring a Back-EMF current at the drive motor. For instance, a detected spike (e.g., above a predetermined threshold) in back-EMF at the drive motor may correspond to and indicate a stall thereof. As an additional or alternative example, 616 may include monitoring a counter-clockwise rotational speed of the fan assembly (e.g., at the flow impeller). For instance, a sudden drop (i.e., reduction) in the rotational speed of the fan assembly may correspond to and indicate a stall thereof. As another additional or alternative example, 616 may include receiving a stall input (e.g., manual indication of stall) at the user interface. For instance, an operator may manually engage a portion of the user interface.

If no stall is determined to be encountered at 616, the method 600 may return to 614. By contrast, if a stall is determined to be encountered at 616, the method 600 may proceed to 618.

At 618, the method 600 includes halting rotation of the flow impeller or the drive motor (e.g., in the counter-clockwise direction immediately following 614). In turn, 614 may continue until 618 is reached and counter-clockwise rotation is halted. Similarly, as described below, 626 may continue until 618 is reached.

At 620, the method 600 includes determining if a trigger cycling occurs (i.e., if the trigger is recycled, such as within a predetermined time period, following 616 or 618. In some embodiments, 620 includes detecting disengagement with the trigger and subsequently detecting reengagement with the user interface. Thus, it may be determined that an operator intended to cease instructions for rotation at the drive motor before prompting a new action.

If the trigger is not recycled, the method 600 may proceed to 622 wherein the tool enters a low-power or sleep mode in which the drive motor is not rotated or power draw at the tool is otherwise reduced. Subsequently, method 600 may proceed to 624 in which the drive motor may be permitted to return to a typical, default, or normal operation, such as to permit rotation of the flow impeller or drive motor in the first direction based on or in response to further engagement with the user interface (e.g., at the trigger).

By contrast, if the trigger is recycled, the method 600 may proceed to 626.

At 626, the method 600 includes rotating the tool (e.g., at the flow impeller or drive motor) clockwise in response to the determined occurrence of trigger cycling at 620. For instance, the drive motor of the fan assembly may be directed to rotate clockwise continuously. The drive motor may rotate exclusively clockwise (e.g., in a pulsating manner or, alternatively, without halting), such as while the trigger remains reengaged.

At 628, the method 600 includes again determining if a stall has been encountered (e.g., as or as part of a stall event at the drive motor). Specifically, 628 may occur during 626. As an example, 628 may include monitoring a Back-EMF current at the drive motor. For instance, a detected spike (e.g., above a predetermined threshold) in back-EMF at the drive motor may correspond to and indicate a stall thereof. As an additional or alternative example, 628 may include monitoring a clockwise rotational speed of the fan assembly (e.g., at the flow impeller). For instance, a sudden drop (i.e., reduction) in the rotational speed of the fan assembly or maintaining of a rotational speed below a set threshold may correspond to and indicate a stall thereof. As another additional or alternative example, 628 may include receiving a continued stall input (e.g., manual indication of stall that has not been cleared) at the user interface.

If a stall is determined to be encountered at 628, the method 600 may return to 618. By contrast, if a stall is not determined to be encountered at 628, the method 600 may proceed to 630 wherein the flow impeller or drive motor is rotated for 100 milliseconds. Subsequently, method 600 may proceed to 624 in which the drive motor may be permitted to return to a typical, default, or normal operation, such as to permit rotation of the flow impeller or drive motor in the first direction based on or in response to further engagement with the user interface (e.g., at the trigger).

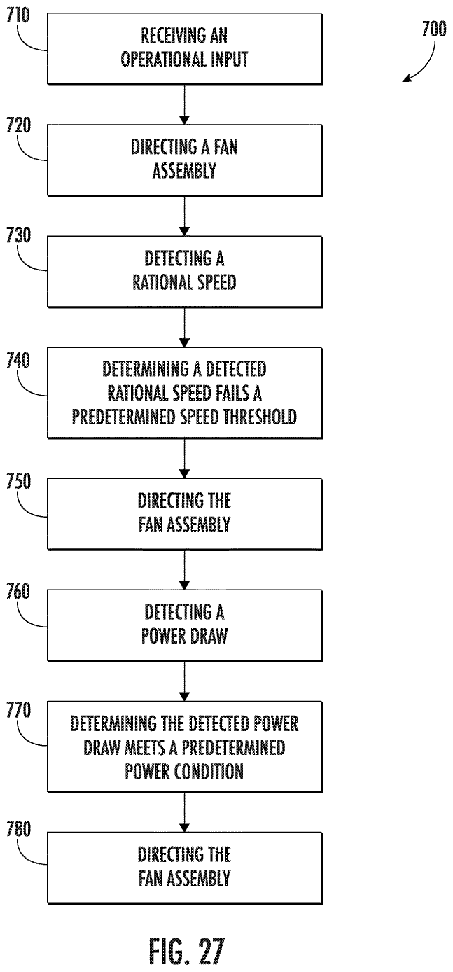

Turning now to FIG. 27, at 710, the method 700 includes receiving an operational input from a user interface. Generally, such an operational input may correspond to or otherwise indicate an operator has engaged a portion of the user interface and intends to activate the tool and, specifically, the fan assembly. For instance, 710 may include receiving a signal from the trigger in response to an operator squeezing, moving, or otherwise engaging the same. Thus, the operational input may include or be provided as a signal from the user interface (e.g., trigger) in response to engagement thereof. As noted above, the trigger may be a variable input in which the signal therefrom varies according to the position or extent to which the trigger is engaged or moved. Thus, the operational input may vary according to the position of the trigger (e.g., trigger pull) or other corresponding input element.

At 720, the method 700 includes directing a drive motor of the fan assembly to rotate (e.g., in a first direction). For instance, 720 may be based on or in response to 710. Generally, the rotation of the drive motor may cause the flow impeller of the fan assembly to rotate (e.g., according to normal operational parameters) and generate an airflow from the inlet nozzle and through the outlet nozzle (e.g., to the debris collection container). Moreover, in certain embodiments, 720 occurs according to a power target in response to receiving the operational input. Thus, the rotation of the drive motor may be driven (e.g., as part of a closed loop cycle) to reach or achieve the power target. The power target may include or be provided as a predetermined value, function, table, or chart. Furthermore, the power target may be based on 710. If the input at 710 is a variable input, the power target may also vary (e.g., according to the position or pull of the trigger).

At 730, the method 700 includes detecting a rotational speed for the drive motor (e.g., as described above). In some embodiments, 730 occurs during 720 (e.g., while directing the drive motor of the fan assembly to rotate according to the power target).

At 740, the method 700 includes determining the detected rotational speed of 730 fails a predetermined speed threshold. In some embodiments, the predetermined speed threshold may include or be provided as a predetermined speed threshold value. For instance, 740 may include determining the detected rotational speed exceeds the predetermined speed threshold value. Optionally, detection of the rotational speed of the predetermined speed threshold value is required to occur for a set (e.g., continuous) time period. Thus, 740 may include determining the detected rotational speed exceeds the predetermined speed threshold value for a set continuous time period.

At 750, the method 700 includes directing the drive motor to rotate (e.g., in the first direction). The directed rotation of 750 may be according to a speed target (e.g., in response to 740). Thus, the power target of 720 may be exchanged, replaced, or supplemented by the speed target (e.g., rotational speed target). In turn, rotation of the drive motor may be driven (e.g., as part of a closed loop cycle) to reach or achieve the speed target. Optionally, the speed target may include a targeted speed range. Such a speed range may be set or predetermined within the controller (e.g., as a predetermined value, function, table, or chart). Additionally or alternatively, the speed range may include a minimum speed value as a negative of a fixed percentage of the speed target and a maximum speed value as a positive of the fixed percentage of the speed target. Thus, the speed range may be +/−the fixed percentage of the speed target.

At 760, the method 700 includes detecting a power draw of the drive motor, during the directed rotation of 750. Thus, 760 may occur while directing the drive motor to rotate according to a speed target. Such a detection may occur at the controller or a separate sensor and would generally be understood in light of the present disclosure.

At 770, the method 700 includes determining the detected power draw of 760 meets a predetermined power condition. For example, if the detected power draw is greater than or equal to the power target of 720 (e.g., exactly or substantially, such as within a set hysteresis value range, such as 10 watts.

At 780, the method 700 includes directing the drive motor to rotate according to a revised target (e.g., following or in response to 770). Optionally, the revised target is a revised power target for a power output of the drive motor (e.g., identical to or different from the power target of 720). Optionally, the power target may include a targeted power range. Such a power range may be set or predetermined within the controller (e.g., as a predetermined value, function, table, or chart). Additionally or alternatively, the power range may include a minimum power value as an applied negative of a fixed coefficient to the power target and a maximum power value as an applied positive of the fixed coefficient to the power target. Thus, the power range may be +/−the fixed coefficient applied to the power target.

Further aspects of the disclosure are provided by one or more of the following embodiments:

Embodiment 1. A debris collection bag for an outdoor tool, the debris collection bag comprising: a fabric body defining an inlet opening, a bag cavity to hold debris therein, and an outlet opening, the fabric body comprising a foldable closing portion extending from the outlet opening and a storage portion extending from the foldable closing portion, the foldable closing portion being movable between a folded-closed position and an unfolded-open position; a bag clasp attached to the fabric body at the foldable closing portion to selectively hold the foldable closing portion in the folded-closed position; and a secondary clasp attached to the fabric body in selective connection with the bag clasp at the foldable closing portion.

Embodiment 2. The debris collection bag of any of any one or more of the embodiments, wherein the fabric body extends along a length direction from a front end to a rear end, wherein the inlet opening is disposed at the front end, and wherein the outlet opening is defined at the rear end.

Embodiment 3. The debris collection bag of any one or more of the embodiments, wherein the secondary clasp is disposed between the outlet opening and the bag clasp.

Embodiment 4. The debris collection bag of any one or more of the embodiments, further comprising an upper batten panel joined to the fabric body along the storage portion above the bag cavity.

Embodiment 5. The debris collection bag of any one or more of the embodiments, further comprising a harness anchor joined to the upper batten panel to receive a connection hook from a user harness.

Embodiment 6. The debris collection bag of any one or more of the embodiments, further comprising a sidewall batten panel joined to the fabric body laterally outward from the bag cavity and below the upper batten panel.

Embodiment 7. The debris collection bag of any one or more of the embodiments, wherein the fabric body defines one or more expansion pleats extending rearward from a tucked end proximal to the inlet opening to an untucked end distal to the inlet opening.

Embodiment 8. A mulching vacuum tool comprising: an inlet nozzle; a housing defining an inlet coupled to the inlet nozzle and an outlet to direct debris from the housing; a fan assembly mounted within the housing between the inlet and the outlet; an outlet nozzle coupled to the outlet; and a user harness comprising a left shoulder strap, a right shoulder strap, a back panel joining the left shoulder strap and the right shoulder strap at a rear portion of the user harness, a front connection panel selectively joining the left shoulder strap and the right shoulder strap at a front portion of the user harness, and a central anchor strap extending between the left shoulder strap and the right shoulder strap in selective connection with the housing.

Embodiment 9. The mulching vacuum tool of claim 8, further comprising a debris container selectively attached to the outlet nozzle to receive debris therefrom.

Embodiment 10. The mulching vacuum tool of claim 9, wherein the user harness further comprises a side anchor strap extending from the back panel, a rear anchor disposed between the left shoulder strap and the right shoulder strap at the rear portion of the user harness, and a container anchor supported on the side anchor strap and connected to the debris container for support thereof.

Embodiment 11. The mulching vacuum tool of any one or more of the embodiments, wherein the side anchor strap extends from the rear anchor to the front connection panel.

Embodiment 12. The mulching vacuum tool of any one or more of the embodiments, wherein the container anchor is slidably disposed on the side anchor strap.

Embodiment 13. The mulching vacuum tool of any one or more of the embodiments, wherein the front connection panel comprises a right clasp supported on the right shoulder strap and a left clasp selectively connected to the right clasp and supported on the left shoulder strap, wherein the side anchor strap is joined to the right clasp, and wherein the central anchor strap is joined to the right clasp.

Embodiment 14. The mulching vacuum tool of any one or more of the embodiments, wherein the front connection panel comprises a right clasp supported on the right shoulder strap and a left clasp selectively connected to the right clasp and supported on the left shoulder strap, and wherein the central anchor strap extends from one of.

Embodiment 15. A mulching vacuum tool comprising: an inlet nozzle; a housing defining an inlet coupled to the inlet nozzle and an outlet to direct debris from the housing, the housing comprising a main body, a first handle extending radially outward from the main body, and a second handle extending radially outward from the main body apart from the first handle; a fan assembly mounted within the housing between the inlet and the outlet; an outlet nozzle coupled to the outlet; and a pair of batteries separately supported on the housing, the pair of batteries comprising a first battery pack and a second battery pack, wherein the pair of batteries, the fan assembly, and the housing define a center of gravity between the first and second handles.

Embodiment 16. The mulching vacuum tool of any one or more of the embodiments, wherein the pair of batteries are each spaced equidistant about the center of gravity of the mulching vacuum tool.

Embodiment 17. The mulching vacuum tool of any one or more of the embodiments, wherein the first handle radially borders the first battery pack, and wherein the second handle radially borders the second battery pack.

Embodiment 18. The mulching vacuum tool of any one or more of the embodiments, wherein the inlet nozzle extends forward from the housing, and wherein the first and second handles are positioned forward from pair of batteries.

Embodiment 19. The mulching vacuum tool of any one or more of the embodiments, wherein the first handle or the second handle comprises a grip body and a contact wire supported on the grip body and exposed to contact a user hand.

Embodiment 20. The mulching vacuum tool of any one or more of the embodiments, further comprising a central anchor mount supported on the housing between the first handle and the second handle to selectively connect with a central anchor strap of a harness.

Embodiment 21. A mulching vacuum tool comprising: an inlet nozzle; a housing defining an inlet coupled to the inlet nozzle and an outlet to direct debris from the housing; an outlet nozzle coupled to the outlet; and a fan assembly mounted within the housing between the inlet and the outlet, the fan assembly comprising a mixed-flow impeller.

Embodiment 22. The mulching vacuum tool of any one or more of the embodiments, wherein the mixed-flow impeller defines an axial height and a radial diameter, and wherein the mixed-flow impeller further defines an impeller ratio of the axial height to the radial diameter of between 0.5 and 1.5.

Embodiment 23. The mulching vacuum tool of any one or more of the embodiments, wherein the housing defines an impeller chamber within which the mixed-flow impeller is enclosed, the impeller chamber extending axially between a chamber intake and a chamber exhaust, wherein a first radial clearance value is defined between the mixed-flow impeller and the housing at the chamber intake, and wherein a second radial clearance value is defined between the mixed-flow impeller and the housing at the chamber exhaust, the second radial clearance value being greater than the first radial clearance value.

Embodiment 24.The mulching vacuum tool of any one or more of the embodiments, wherein a radial clearance dimension been the mixed-flow impeller and the housing increases gradually along an axial direction from the first radial clearance value.

Embodiment 25. The mulching vacuum tool of any one or more of the embodiments, wherein the first radial clearance value is between 4 millimeters and 7 millimeters, and wherein the second radial clearance value is between 6 millimeters and 9 millimeters.

Embodiment 26. The mulching vacuum tool of any one or more of the embodiments, wherein the housing defines an impeller chamber within which the mixed-flow impeller is enclosed, the impeller chamber extending axially between a chamber intake and a chamber exhaust, and wherein the mixed-flow impeller defines an exhaust-flow angle between 20 degrees and 80 degrees relative to an axial direction.

Embodiment 27. The mulching vacuum tool of any one or more of the embodiments, wherein the mixed-flow impeller extends axially between an intake end and an exhaust end, and wherein the mixed-flow impeller defines an exhaust diameter at the exhaust end between 80 millimeters and 160 millimeters.

Embodiment 28. The mulching vacuum tool of any one or more of the embodiments, wherein the mixed-flow impeller extends axially between an intake end and an exhaust end, wherein the mixed-flow impeller defines an intake diameter at the intake end, wherein the mixed-flow impeller defines an exhaust diameter at the exhaust end, wherein the mixed-flow impeller further defines a diameter ratio of the intake diameter to the exhaust diameter of between 0.5 and 0.9.

Embodiment 29. The mulching vacuum tool of any one or more of the embodiments, wherein the mixed-flow impeller extends axially between an intake end and an exhaust end, and wherein the mixed-flow impeller defines an exhaust diameter at the exhaust end between 80 millimeters and 160 millimeters.

Embodiment 30. The mulching vacuum tool of any one or more of the embodiments, wherein the mixed-flow impeller defines an axial height extending axially between an intake end and an exhaust end, the axial height being between 60 millimeters and 140 millimeters.

Embodiment 31. A mulching vacuum tool comprising: an inlet nozzle; a housing defining an inlet coupled to the inlet nozzle and an outlet to direct debris from the housing; an outlet nozzle coupled to the outlet; and a fan assembly mounted within the housing between the inlet and the outlet, the fan assembly comprising a mixed-flow impeller, wherein the mixed-flow impeller defines an axial height and a radial diameter, wherein the mixed-flow impeller further defines an impeller ratio of the axial height to the radial diameter of between 0.5 and 1.5, wherein the housing defines an impeller chamber within which the mixed-flow impeller is enclosed, the impeller chamber extending axially between a chamber intake and a chamber exhaust, wherein a first radial clearance value is defined between the mixed-flow impeller and the housing at the chamber intake, and wherein a second radial clearance value is defined between the mixed-flow impeller and the housing at the chamber exhaust, the second radial clearance value being greater than the first radial clearance value.

Embodiment 32. The mulching vacuum tool of any one or more of the embodiments, wherein a radial clearance dimension been the mixed-flow impeller and the housing increases gradually along an axial direction from the first radial clearance value.

Embodiment 33. The mulching vacuum tool of any one or more of the embodiments, wherein the first radial clearance value is between 4 millimeters and 7 millimeters, and wherein the second radial clearance value is between 6 millimeters and 9 millimeters.

Embodiment 34. The mulching vacuum tool of any one or more of the embodiments, wherein the housing defines an impeller chamber within which the mixed-flow impeller is enclosed, the impeller chamber extending axially between a chamber intake and a chamber exhaust, and wherein the mixed-flow impeller defines an exhaust-flow angle between 20 degrees and 80 degrees relative to an axial direction.

Embodiment 35. The mulching vacuum tool of any one or more of the embodiments, wherein the mixed-flow impeller extends axially between an intake end and an exhaust end, and wherein the mixed-flow impeller defines an exhaust diameter at the exhaust end between 80 millimeters and 160 millimeters.

Embodiment 36. The mulching vacuum tool of any one or more of the embodiments, wherein the mixed-flow impeller extends axially between an intake end and an exhaust end, wherein the mixed-flow impeller defines an intake diameter at the intake end, wherein the mixed-flow impeller defines an exhaust diameter at the exhaust end, wherein the mixed-flow impeller further defines a diameter ratio of the intake diameter to the exhaust diameter of between 0.5 and 0.9.

Embodiment 37. The mulching vacuum tool of any one or more of the embodiments, wherein the mixed-flow impeller extends axially between an intake end and an exhaust end, and wherein the mixed-flow impeller defines an exhaust diameter at the exhaust end between 80 millimeters and 160 millimeters.

Embodiment 38. The mulching vacuum tool of any one or more of the embodiments, wherein the mixed-flow impeller defines an axial height extending axially between an intake end and an exhaust end, the axial height being between 60 millimeters and 140 millimeters.

Embodiment 39. A method of operating a mulching vacuum comprising: receiving an operational input from a user interface; directing a drive motor of a fan assembly to rotate in a first direction in response to receiving the operational input; detecting a stall event at the drive motor while directing the drive motor of the fan assembly to rotate; and initiating an unclogging sequence at the drive motor based on detecting the stall event, initiating the unclogging sequence comprising directing the drive motor of the fan assembly to rotate in a second direction opposite the first direction.

Embodiment 40. The method of any one or more of the embodiments, wherein detecting the stall event comprises monitoring a Back-EMF current at the drive motor.

Embodiment 41. The method of any one or more of the embodiments, wherein detecting the stall event comprises monitoring a rotational speed of the fan assembly in the first direction.

Embodiment 42. The method of any one or more of the embodiments, further comprising detecting a cycling of the operational input at the user interface, wherein initiating the unclogging sequence is in response to detecting the cycling.

Embodiment 43. The method of any one or more of the embodiments, wherein the cycling of the operational input comprises detecting disengagement with the user interface following receiving the operational input, and detecting reengagement with the user interface following detecting disengagement, wherein the method further comprises: detecting renewed disengagement with the user interface following detecting the cycling of the operational input; and halting the unclogging sequence in response to detecting renewed disengagement with the user interface.

Embodiment 44. The method of any one or more of the embodiments, further comprising: determining a stall absence during the unclogging sequence; and halting the unclogging sequence in response to determining the stall absence.

Embodiment 45. The method of any one or more of the embodiments, wherein detecting the stall event comprises receiving a stall input at the user interface.

Embodiment 46. The method of any one or more of the embodiments, wherein the unclogging sequence comprises alternating rotation of the drive motor of the fan assembly between the second direction and the first direction.

Embodiment 47. The method of any one or more of the embodiments, wherein the unclogging sequence comprises directing the drive motor of the fan assembly to rotate in a second direction continuously.

Embodiment 48. The method of any one or more of the embodiments, further comprising: determining a stall absence during the unclogging sequence; and halting the unclogging sequence in response to determining the stall absence.

Embodiment 49. A mulching vacuum tool comprising: an inlet nozzle; a housing defining an inlet coupled to the inlet nozzle and an outlet to direct debris from the housing; a user interface mounted to the housing; an outlet nozzle coupled to the outlet; a fan assembly mounted within the housing between the inlet and the outlet, the fan assembly comprising an airflow impeller and a drive motor in mechanical communication with the airflow impeller; and a controller in operable communication with the user interface and the drive motor, the controller being configured to control the drive motor according to a motor operation comprising: receiving an operational input from the user interface, directing the drive motor of the fan assembly to rotate in a first direction in response to receiving the operational input, detecting a stall event at the drive motor while directing the drive motor of the fan assembly to rotate, and initiating an unclogging sequence at the drive motor based on detecting the stall event, initiating the unclogging sequence comprising directing the drive motor of the fan assembly to rotate in a second direction opposite the first direction.

Embodiment 50. The mulching vacuum tool of any one or more of the embodiments, wherein detecting the stall event comprises monitoring a Back-EMF current at the drive motor.

Embodiment 51. The mulching vacuum tool of any one or more of the embodiments, wherein detecting the stall event comprises monitoring a rotational speed of the fan assembly in the first direction.

Embodiment 52. The mulching vacuum tool of any one or more of the embodiments, wherein the motor operation further comprises: detecting a cycling of the operational input at the user interface, wherein initiating the unclogging sequence is in response to detecting the cycling.

Embodiment 53. The mulching vacuum tool of any one or more of the embodiments, wherein the cycling of the operational input comprises detecting disengagement with the user interface following receiving the operational input, and detecting reengagement with the user interface following detecting disengagement, wherein the motor operation further comprises: detecting renewed disengagement with the user interface following detecting the cycling of the operational input, and halting the unclogging sequence in response to detecting renewed disengagement with the user interface.

Embodiment 54. The mulching vacuum tool of any one or more of the embodiments, motor operation further comprises: determining a stall absence during the unclogging sequence; and halting the unclogging sequence in response to determining the stall absence.

Embodiment 55. The mulching vacuum tool of any one or more of the embodiments, wherein detecting the stall event comprises receiving a stall input at the user interface.

Embodiment 56. The mulching vacuum tool of any one or more of the embodiments, wherein the unclogging sequence comprises alternating rotation of the drive motor of the fan assembly between the second direction and the first direction.

Embodiment 57. The mulching vacuum tool of any one or more of the embodiments, wherein the unclogging sequence comprises directing the drive motor of the fan assembly to rotate in a second direction continuously.

Embodiment 58. The mulching vacuum tool of any one or more of the embodiments, wherein the motor operation further comprises: determining a stall absence during the unclogging sequence; and halting the unclogging sequence in response to determining the stall absence.

Embodiment 59. A method of operating a mulching vacuum comprising: receiving an operational input from a user interface; directing a drive motor of a fan assembly to rotate according to a power target in response to receiving the operational input; detecting a rotational speed for the drive motor while directing the drive motor of the fan assembly to rotate according to the power target; determining the detected rotational speed fails a predetermined speed threshold; and directing, in response to determining the detected rotational speed fails the predetermined speed threshold, the drive motor to rotate according to a speed target.

Embodiment 60. The method of any one or more of the embodiments, wherein the operational input is a variable input and wherein the power target comprises a variable power target based on the variable input.

Embodiment 61. The method of any one or more of the embodiments, wherein determining the detected rotational speed fails the predetermined speed threshold comprises determining the detected rotational speed exceeds a predetermined speed threshold value.

Embodiment 62. The method of any one or more of the embodiments, wherein determining the detected rotational speed exceeds the predetermined speed threshold value comprises determining the detected rotational speed exceeds the predetermined speed threshold value for a set continuous time period.

Embodiment 63. The method of any one or more of the embodiments, wherein the speed target comprises a targeted speed range, and wherein the predetermined speed threshold value lies within the targeted speed range.

Embodiment 64. The method of any one or more of the embodiments, wherein the targeted speed range comprises a minimum speed value as a negative of a fixed percentage of the speed target and a maximum speed value as a positive of the fixed percentage of the speed target.

Embodiment 65. The method of any one or more of the embodiments, further comprising: detecting a power draw of the drive motor while directing the drive motor to rotate according to a speed target; determining the detected power draw meets a predetermined power condition; and directing, in response to determining the detected power draw meets the predetermined power condition, the drive motor to rotate according to a revised target.

Embodiment 66. The method of any one or more of the embodiments, wherein the revised target is a revised power target for a power output of the drive motor.

Embodiment 67. The method of any one or more of the embodiments, wherein the revised power target comprises a targeted power range, and wherein the power target lies within the targeted power range.

Embodiment 68. The method of any one or more of the embodiments, wherein the targeted power range comprises a minimum power value as an applied negative of a fixed coefficient to the power target and a maximum power value as an applied positive of the fixed coefficient to the power target.

Embodiment 69. A mulching vacuum tool comprising: an inlet nozzle; a housing defining an inlet coupled to the inlet nozzle and an outlet to direct debris from the housing; a user interface mounted to the housing; an outlet nozzle coupled to the outlet; a fan assembly mounted within the housing between the inlet and the outlet, the fan assembly comprising an airflow impeller and a drive motor in mechanical communication with the airflow impeller; and a controller in operable communication with the user interface and the drive motor, the controller being configured to control the drive motor according to a motor operation comprising: receiving an operational input from the user interface, directing the drive motor of the fan assembly to rotate according to a power target in response to receiving the operational input, detecting a rotational speed for the drive motor while directing the drive motor of the fan assembly to rotate according to the power target, determining the detected rotational speed fails a predetermined speed threshold, and directing, in response to determining the detected rotational speed fails the predetermined speed threshold, the drive motor to rotate according to a speed target.

Embodiment 70. The mulching vacuum tool of any one or more of the embodiments, wherein the operational input is a variable input and wherein the power target comprises a variable power target based on the variable input.

Embodiment 71. The mulching vacuum tool of any one or more of the embodiments, wherein determining the detected rotational speed fails the predetermined speed threshold comprises determining the detected rotational speed exceeds a predetermined speed threshold value.

Embodiment 72. The mulching vacuum tool of any one or more of the embodiments, wherein determining the detected rotational speed exceeds the predetermined speed threshold value comprises determining the detected rotational speed exceeds the predetermined speed threshold value for a set continuous time period.

Embodiment 73. The mulching vacuum tool of any one or more of the embodiments, wherein the speed target comprises a targeted speed range, and wherein the predetermined speed threshold value lies within the targeted speed range.

Embodiment 74. The mulching vacuum tool of any one or more of the embodiments, wherein the targeted speed range comprises a minimum speed value as a negative of a fixed percentage of the speed target and a maximum speed value as a positive of the fixed percentage of the speed target.

Embodiment 75. The mulching vacuum tool of any one or more of the embodiments, wherein the motor operation further comprises: detecting a power draw of the drive motor while directing the drive motor to rotate according to a speed target, determining the detected power draw meets a predetermined power condition, and directing, in response to determining the detected power draw meets the predetermined power condition, the drive motor to rotate according to a revised target.

Embodiment 76. The mulching vacuum tool of any one or more of the embodiments, wherein the revised target is a revised power target for a power output of the drive motor.

Embodiment 77. The mulching vacuum tool of any one or more of the embodiments, wherein the revised power target comprises a targeted power range, and wherein the power target lies within the targeted power range.

Embodiment 78. The mulching vacuum tool of any one or more of the embodiments, wherein the targeted power range comprises a minimum power value as an applied negative of a fixed coefficient to the power target and a maximum power value as an applied positive of the fixed coefficient to the power target.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A debris collection bag for an outdoor tool, the debris collection bag comprising:
a fabric body defining an inlet opening, a bag cavity to hold debris therein, and an outlet opening, the fabric body comprising a foldable closing portion extending from the outlet opening and a storage portion extending from the foldable closing portion, the foldable closing portion being movable between a folded-closed position and an unfolded-open position;
a bag clasp attached to the fabric body at the foldable closing portion to selectively hold the foldable closing portion in the folded-closed position; and
a secondary clasp attached to the fabric body in selective connection with the bag clasp at the foldable closing portion.

2. The debris collection bag of claim 1, wherein the fabric body extends along a length direction from a front end to a rear end, wherein the inlet opening is disposed at the front end, and wherein the outlet opening is defined at the rear end.

3. The debris collection bag of claim 1, wherein the secondary clasp is disposed between the outlet opening and the bag clasp.

4. The debris collection bag of claim 1, further comprising an upper batten panel joined to the fabric body along the storage portion above the bag cavity.

5. The debris collection bag of claim 4, further comprising a harness anchor joined to the upper batten panel to receive a connection hook from a user harness.

6. The debris collection bag of claim 4, further comprising a sidewall batten panel joined to the fabric body laterally outward from the bag cavity and below the upper batten panel.

7. The debris collection bag of claim 1, wherein the fabric body defines one or more expansion pleats extending rearward from a tucked end proximal to the inlet opening to an untucked end distal to the inlet opening.

8. A mulching vacuum tool comprising:
an inlet nozzle;
a housing defining an inlet coupled to the inlet nozzle and an outlet to direct debris from the housing;
a fan assembly mounted within the housing between the inlet and the outlet;
an outlet nozzle coupled to the outlet; and
a user harness comprising a left shoulder strap, a right shoulder strap, a back panel joining the left shoulder strap and the right shoulder strap at a rear portion of the user harness, a front connection panel selectively joining the left shoulder strap and the right shoulder strap at a front portion of the user harness, and a central anchor strap extending between the left shoulder strap and the right shoulder strap in selective connection with the housing.

9. The mulching vacuum tool of claim 8, further comprising a debris container selectively attached to the outlet nozzle to receive debris therefrom.

10. The mulching vacuum tool of claim 9, wherein the user harness further comprises
a side anchor strap extending from the back panel,
a rear anchor disposed between the left shoulder strap and the right shoulder strap at the rear portion of the user harness, and
a container anchor supported on the side anchor strap and connected to the debris container for support thereof.

11. The mulching vacuum tool of claim 10, wherein the side anchor strap extends from the rear anchor to the front connection panel.

12. The mulching vacuum tool of claim 11, wherein the container anchor is slidably disposed on the side anchor strap.

13. The mulching vacuum tool of claim 11, wherein the front connection panel comprises a right clasp supported on the right shoulder strap and a left clasp selectively connected to the right clasp and supported on the left shoulder strap,
wherein the side anchor strap is joined to the right clasp, and
wherein the central anchor strap is joined to the right clasp.

14. The mulching vacuum tool of claim 8, wherein the front connection panel comprises a right clasp supported on the right shoulder strap and a left clasp selectively connected to the right clasp and supported on the left shoulder strap, and
wherein the central anchor strap extends from one of.

15. A mulching vacuum tool comprising:
an inlet nozzle;
a housing defining an inlet coupled to the inlet nozzle and an outlet to direct debris from the housing, the housing comprising a main body, a first handle extending radially outward from the main body, and a second handle extending radially outward from the main body apart from the first handle;
a fan assembly mounted within the housing between the inlet and the outlet;
an outlet nozzle coupled to the outlet; and
a pair of batteries separately supported on the housing, the pair of batteries comprising a first battery pack and a second battery pack,
wherein the pair of batteries, the fan assembly, and the housing define a center of gravity between the first and second handles.

16. The mulching vacuum tool of claim 15, wherein the pair of batteries are each spaced equidistant about the center of gravity of the mulching vacuum tool.

17. The mulching vacuum tool of claim 15, wherein the first handle radially borders the first battery pack, and
wherein the second handle radially borders the second battery pack.

18. The mulching vacuum tool of claim 17, wherein the inlet nozzle extends forward from the housing, and
wherein the first and second handles are positioned forward from pair of batteries.

19. The mulching vacuum tool of claim 15, wherein the first handle or the second handle comprises a grip body and a contact wire supported on the grip body and exposed to contact a user hand.

20. The mulching vacuum tool of claim 15, further comprising a central anchor mount supported on the housing between the first handle and the second handle to selectively connect with a central anchor strap of a harness.
